(19) United States
(12) Patent Application Publication
(10) Pub. No.: US 2017/0076677 A1
(43) Pub. Date: Mar. 16, 2017

(54) ENHANCEMENT FOR USE OF A DISPLAY IN A SOFTWARE CONFIGURABLE LIGHTING DEVICE

(71) Applicant: ABL IP Holding LLC, Conyers, GA (US)

(72) Inventors: Guan-Bo LIN, Reston, VA (US); Ravi KOMANDURI, Dulles, VA (US); Rashmi Kumar RAJ, Herndon, VA (US); David P. RAMER, Reston, VA (US); Jack C. RAINS, Herndon, VA (US)

(21) Appl. No.: 15/350,788

(22) Filed: Nov. 14, 2016

Related U.S. Application Data
(62) Division of application No. 15/244,402, filed on Aug. 23, 2016.
(60) Provisional application No. 62/209,546, filed on Aug. 25, 2015.

(51) Int. Cl. G09G 3/34; G09G 3/36; H05B 37/02

(52) U.S. Cl. CPC G09G 3/3426; H05B 37/0209; G09G 3/3607; G09G 2320/0646; G02F 1/133504

(57) ABSTRACT

The examples relate to various implementations of a software configurable lighting device, having an enhance display device that is able to generate light sufficient to provide general illumination of a space in which the lighting device is installed and provide an image display. The general illumination is provided by additional light sources and/or improved display components of the enhanced display device.

### CROSS-REFERENCE TO RELATED APPLICATION

This application is a divisional of U.S. patent application Ser. No. 15/244,402 filed on Aug. 23, 2016 which claims priority of U.S. Provisional Patent Application No. 62/209,546, filed on Aug. 25, 2015 and entitled “ENHANCEMENTS FOR USE OF A DISPLAY IN A SOFTWARE CONFIGURABLE LIGHTING DEVICE,” the entire contents of both of which are incorporated herein by reference.

### TECHNICAL FIELD

The present subject matter relates to lighting devices, and to configurations and/or operations thereof, whereby a lighting device configurable by software, e.g. to emulate a variety of different lighting devices, uses an enhanced display device.

### BACKGROUND

Electrically powered artificial lighting has become ubiquitous in modern society. Electrical lighting devices are commonly deployed, for example, in homes, buildings of commercial and other enterprise establishments, as well as in various outdoor settings.

In conventional lighting devices, the luminance output can be turned ON/OFF and often can be adjusted up or dimmed down. In some devices, e.g. using multiple colors of light emitting diode (LED) type sources, the user may be able to adjust a combined color output of the resulting illumination. The changes in intensity or color characteristics of the illumination may be responsive to manual user inputs or responsive to various sensed conditions in or about the illuminated space. The optical distribution of the light output, however, typically is fixed. Various different types of optical elements are used in such lighting devices to provide different light output distributions, but each type of device has a specific type of optic designed to create a particular light distribution for the intended application of the lighting device. The dimming and/or color control features do not affect the distribution pattern of the light emitted from the luminaire.

To the extent that multiple distribution patterns are needed for different lighting applications, multiple luminaries must be provided. To meet the demand for different appearances and/or different performance (including different distributions), a single manufacturer of lighting devices may build and sell thousands of different luminaries.

Some special purpose light fixtures, for example, fixtures designed for stage or studio type lighting, have implemented mechanical adjustments. Mechanically adjustable lenses and irises enable selectable adjustment of the output light beam shape, and mechanically adjustable gimbal fixture mounts or the like enable selectable adjustment of the angle of the fixture and thus the direction of the light output. The adjustments provided by these mechanical approaches are implemented at the overall fixture output, provide relatively coarse overall control, and are really optimized for special purpose applications, not general lighting.

There have been more recent proposals to develop lighting devices offering electronically adjustable light beam distributions, using a number of separately selectable/controllable solid state lamps or light engines within one light fixture. In at least some cases, each internal light engine or lamp may have an associated adjustable electro-optic component to adjust the respective light beam output, thereby providing distribution control for the overall illumination output of the fixture.

Although the more recent proposals provide a greater degree of distribution adjustment and may be more suitable for general lighting applications, the outward appearance of each lighting device remains the same even as the device output light distribution is adjusted. There may also be room for still further improvement in the degree of adjustment supported by the lighting device.

There also have been proposals to use displays or display-like devices mounted in or on the ceiling to provide variable lighting. The Fraunhofer Institute, for example, has demonstrated a lighting system using luminous tiles, each having a matrix of red (R) LEDs, green (G), blue (B) LEDs and white (W) LEDs as well as a diffuser film to process light from the various LEDs. The LEDs of the system were driven to simulate or mimic the effects of clouds moving across the sky. Although use of displays allows for variations in appearance that some may find pleasing, the displays or display-like devices are optimized for image output and do not provide particularly good illumination for general lighting applications. A display typically has a Lambertian output distribution over substantially the entire surface area of the display screen, which does not provide the white light intensity and coverage area at a floor or ceiling height offered by a similarly sized ceiling-mounted light fixture. Liquid crystal displays (LCD) also are rather inefficient. For example, backlights in LCD televisions have to produce almost ten times the amount of light that is actually delivered at the viewing surface. Therefore, any LCD displays that are to be used as lighting products need to be more efficient than typical LCD displays for the lighting device implementation to be commercially viable.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is high-level functional block diagram of an example of a software configurable lighting apparatus.

FIG. 2 is a plan view of a display device, enhanced with one or more sources that may be implemented in a software configurable lighting apparatus, like that of FIG. 1

FIGS. 3A and 3B are partial cross-sectional views in the vicinity of one corner (roughly along line A-A) to show an angled arrangement and a horizontal arrangement respectively of the illumination and modulation type configurable lighting elements relative to the plane of the light panel.

FIG. 3C is an enlarged cross-sectional view along line B-B of FIG. 2, for another example where the illumination and modulation type configurable lighting elements are perpendicular to the plane of the light panel.

FIG. 4 is high-level functional block diagram of another example of a software configurable lighting apparatus.

FIG. 5A is a high-level functional block diagram of a system for providing configuration or setting information to a software configurable lighting device, based on a user selection.

FIG. 5B is a ping-pong chart type signal flow diagram, of an example of a procedure for loading configuration information to a software configurable lighting device, in a system like that of FIG. 5A.

FIG. 6 is an example of components of a prior art commercial-off-the-shelf back lit liquid crystal display (LCD) device.

FIG. 7A is an example of enhanced components of an enhanced LCD device usable as a software configurable lighting apparatus of FIG. 4.

FIG. 7B is another example of enhanced components of an enhanced LCD device usable as a software configurable lighting apparatus of FIG. 4.

FIGS. 7C and 7D illustrate characteristics of another example of components of an enhanced LCD device based on a viewing angle of an occupant of a premises in which a software configurable lighting apparatus, such as that shown in FIG. 4, is located.

FIG. 8 illustrates an example of the operation of a polymer disbursed liquid crystals (PDLC) system usable in an example of an enhanced LCD, such as that of FIGS. 7A and 7B.

FIG. 9A illustrates another example of a channelized color separating configuration usable in the example of a software configurable lighting apparatus of FIGS. 7A and 7B.

FIG. 9B illustrates an example of a color separating film configuration usable in the example of an enhanced LCD, such as that of FIG. 9A.

FIG. 10 is an exploded isometric view of a liquid crystal (LC) stack configured as an optical, spatial modulator as may be used in the software configurable lighting apparatus examples, such as in FIG. 4.

FIG. 11A illustrates a cross-section of an example of an organic light emitting diode (OLED) usable in a software configurable lighting apparatus, such as that of FIG. 4.

FIG. 11B illustrates a top-view diagram of a single OLED within a stack of OLEDs usable in an example of a software configurable lighting apparatus, such as that of FIG. 4.

FIGS. 11C and 11D illustrate exploded cross-sectional view of other examples of stackable OLEDs usable in the example of a software configurable lighting apparatus of FIG. 4.

FIG. 11E illustrates examples of various states of an OLED usable in the examples of FIGS. 11A-11D.

FIGS. 12A and 12B illustrate examples of non-organic back lighting of a transparent OLED and the response of the transparent OLED to the non-organic back light for use in a stack of OLEDs, such as those shown in FIGS. 10C and-10D.

FIG. 12C illustrates an example of display array and illumination array configuration usable in a software configurable lighting apparatus, such as that of FIG. 4.

FIG. 13 is a high-level example of a portion of an array of microstrip resonators in a plasma display for providing a software configurable lighting apparatus, such as that of FIG. 4.

FIG. 13A is an example of a 3-cut resonator of a plasma display cell usable in an example of a software configurable lighting apparatus, such as that of FIG. 4.

FIG. 13B is a plan view diagramming the location of the occurrence of microplasma generated by a 3-cut resonator like that illustrated in the example of FIG. 13.

FIG. 13C illustrates an example of a portion of color filter implementation suitable for use with the 3-cut resonator example of FIG. 13.

FIGS. 14A and 14B illustrate examples of semiconductor layer arrangements for providing the 3-cut resonator in a cell of a microplasma display as illustrated in the example of FIG. 13.

FIG. 15 illustrates an example of a high-level control system configuration for controlling an array of 3-cut resonators, as in the portion of an array as in FIG. 13A to provide a software configurable lighting apparatus, such as that of FIG. 4.

FIG. 15A is a partial isometric view of an example of an RF microstrip resonator array in a plasma display as shown in the FIG. 13.

FIG. 15B is a partial isometric view of an addressable array of RF microstrip resonators as shown in FIG. 15A.

FIG. 16 is a timing diagram useful in understanding a time division multiplexing approach to the display and lighting functions.

FIG. 17 is a simplified functional block diagram of a computer that may be configured as a host or server, for example, to supply configuration information or other data to a software configurable lighting apparatus, such as that of FIGS. 1 and 1A, e.g., in a system like that of FIG. 5A.

FIG. 18 is a simplified functional block diagram of a personal computer or other similar user terminal device, which may communicate with a software configurable lighting apparatus.

FIG. 19 is a simplified functional block diagram of a mobile device, as an alternate example of a user terminal device, for possible communication with a software configurable lighting apparatus.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various examples disclosed herein relate to a lighting platform that enables virtual luminaries and light distributions to be created in software, for example, while offering the performance and aesthetic characteristics of a catalogue luminaire or whatever distribution and aesthetic appearance a designer may envision. The examples described in detailed below and shown in the drawings typically implement one or more techniques to enhance currently existing display technologies to provide the dual functionality of a display and luminaire, particularly in a manner to more effectively support luminaire type general lighting applications.

Some examples describe apparatuses that include display devices that produce an image display output with ways to enable the display device to produce an illumination light output with industry acceptable performance for a general lighting application of a luminaire. Examples of ways to enable the display device to produce an illumination light include, but are not limited to, one or more of an enhanced light backlight source an additional, collated light source; an organic light emitting diode layer; a display layer formed from polymer disbursed liquid crystals; a display layer formed from polymer stabilized cholesteric texture liquid crystals; or a microplasma cell.

Displays that use liquid crystals (LC) as an element of the display usually suffer a high optical losses. For example, the final light output is usually less than 10% of what was originally produced by the Back-Light Unit. This reduces the efficiency of a display to the extent that the display's illumination efficiency cannot compare with standard luminaire efficiencies which are in the range of 100 lumens/watt. In fact, most LCD displays cannot perform better than 10 lumens/watt. In other words, the general illumination performance of a conventional LCD based display does not satisfy minimal lighting requirements set by building codes or industry standards, such as Illuminating Engineering Society (IES) and American National Standards Institute (ANSI) standards. Other display technologies, such projection displays, LED-LCD or plasma displays are optimized for the display function and offer poor illumination efficiency, and thus as similarly unsuited to general lighting. In addition, many displays usually use combinations of narrow bandwidth emitters as the sources, therefore the light output is not spectrally filled as one would expect from a typical white light luminaire. This directly relates to metrics such as CRI and R9. As a result, a display without some enhancements is a poor substitute for a standard luminaire.

Beam shape is another issue when using a display for lighting purposes. Luminaries, which are typically mounted in ceilings are specifically designed to cover the lighting solid angle appropriate to throw light on a work surface or the like within a room. For example, downlights have a narrow beam cone, while other lights may disburse the light over a wider area of the room. Conversely, displays are designed with the intention of covering a broad viewing angle. The light output by a display at the broad viewing angle is considered wasteful from a luminaire's perspective. For this additional reason, displays are not typically considered as effective alternatives to a dedicated light fixture for general lighting purposes.

A software configurable lighting device, installed for example as a panel, offers the capability to appear like and emulate a variety of different lighting devices. Emulation may include the appearance of the lighting device as installed in the wall or ceiling, possibly both when and when not providing lighting, as well as light output distribution, e.g. direction and/or beam shape.

Multiple software configurable lighting device panels may be installed in a room. These panels may be networked together to form one display. In such an installation example, this network of panels will allow appropriate configurable lighting in the room. The appearance of each installed lighting device may be an image of a lighting device presented on an image display device as described herein. The general illumination may be provided via additional light sources collocated with the image display device, or may be provided by the image display device that is enhanced to provide output light complying with governmental building codes and/or lighting industry standards.

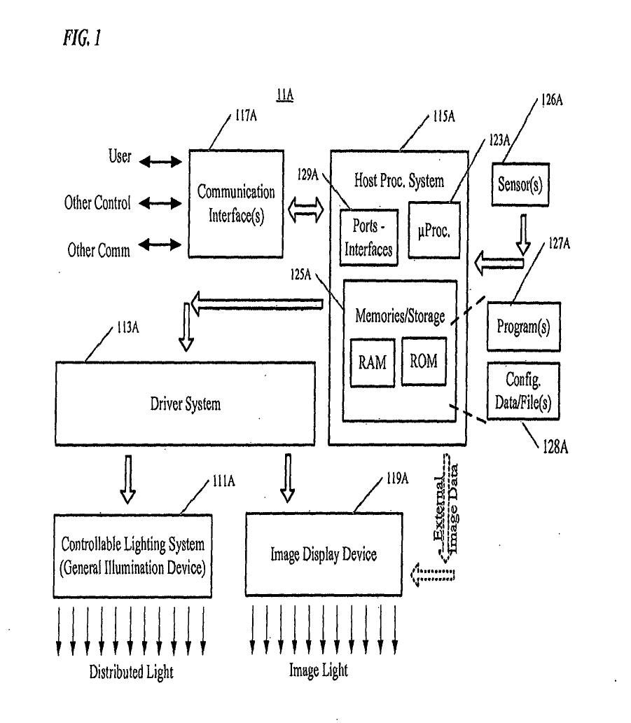

Reference now is made in detail to the examples illustrated in the accompanying drawings and discussed below. As shown in FIG. 1, the controllable lighting system 111A provides general illumination lighting in response to control signals received from the driver system 113A. Similarly, the image display device 119A provides image light in response to control signals received from the driver system 113A. In addition or alternatively, the image data may be provided to the image display device 119A from an external source(s) (not shown), such as a remote server or an external memory device via one or more of the communication interfaces 117A. The functions of elements 111A and 119A are controlled by the control signals received from the driver system 113A. The image display device 119A may be either a commercial-off-the-shelf image display device or an enhanced display device (described in more detail in the following examples) that provides general illumination lighting that complies with governmental building codes and/or industry lighting standards. The image display device 119A is configured to present an image. The presented image may be a real scene, a computer generated scene, a single color, a collage of colors, a video stream, or the like. The controllable lighting system 111A is a general illumination device that is collocated with the image display device 119A, and that includes light sources (described in the following examples) that provide general illumination that satisfies governmental building codes and/or industry lighting standards.

In example of the operation of the lighting device, the processor 123A receives a configuration file 128A via one or more of communication interfaces 117A. The processor 123 may store, or cache, the received configuration file 128 in storage/memories 125. The configuration file 128A includes configuration data that indicates, for example, an image for display by the image display device 119A as well as lighting settings for light to be provided by the configurable lighting device 11. Using the indicated image data, the processor 123A may retrieve from memory 125A stored image data, which is then delivered to the driver system 113A. The driver system 113A may deliver the image data directly to the image display device 119A for presentation or may have to convert the image data into a format suitable for delivery to the image display device 119A. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (Exif) or the like. For example, if floating point precision is needed, options are available, such as OpenEXR, to store 32-bit linear values. In addition, the hypertext transfer protocol (HTTP), which supports compression as a protocol level feature, may also be used.

In another example, if the image display device 119A is enhanced with modified modulation components, the configuration data operating state of any light processing and modulation components of the enhanced image display device. Each configuration file also includes software control data to set the light output parameters of the software configurable lighting device at least with respect to the controllable lighting system 111A. As mentioned, the configuration information in the file 128A may specify operational parameters of the controllable lighting system 111A, such as light intensity, light color characteristic, image parameters and the like, as well as the operating state of any light processing and modulation components of the controllable image generation and lighting system 111A. The processor 123A by accessing programming 127A and using software configuration information 128A, from the storage/memories 125A, controls operation of the driver system 113A, and through that system 113A controls the controllable image generation and lighting system 111A and may control the image display device 119A. For example, the processor 123A obtains distribution control data from a configuration file 128A, and uses that data to control the driver system 113A to cause the display of an image via the image display device 119A and also set operating states of the light processing and modulation components of the controllable lighting system 111A to optically, spatially modulate output of a light source (not shown) to produce a selected light distribution, e.g. to achieve a predetermined image presentation and a predetermined light distribution for a general illumination application of a luminaire.

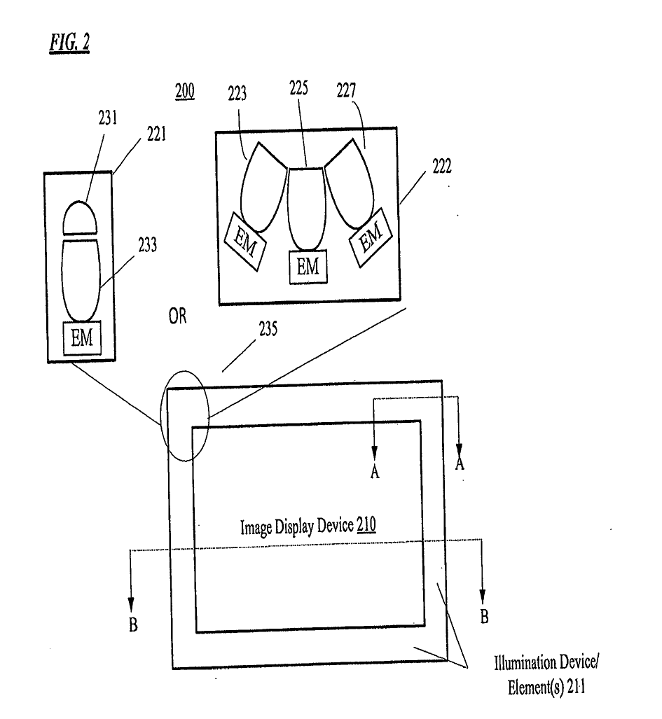

In other examples, the driver system 113 is coupled to the memory 125, the image display device 119A and the controllable lighting system 111A (or 211 of FIG. 2)) to control light generated by the image display device 119A and the controllable lighting system 111A based on the configuration data 128A stored in the memory 125A. In such an example, the driver system 113A is configured to access configuration data 128A stored in the memory 125A and generate control signals for presenting the image on the image display device 119A and control signals for generating light for output from the general illumination device 111A. For example, the image display device 119A includes inputs coupled to the driver system 113A for receiving image data according to the configuration data 128A stored in the memory. Examples of the image data includes video data or still image data stored in the memory 125A. The driver system 113A may also deliver control signals for presenting the image on the image display device 119A that are generated based on the received image data.

The first drawing also provides an example of an implementation of the high layer logic and communications elements and one or more drivers to drive the source 110A and the spatial modulator 111A to provide a selected light output distribution, e.g. for a general illumination application. As shown in FIG. 1, the lighting device 11A includes a driver system 113A, a host processing system 115A, one or more sensors 121A and one or more communication interface(s) 117A.

The host processing system 115A provides the high level logic or “brain” of the device 11. In the example, the host processing system 115A includes data storage/memories 125A, such as a random access memory and/or a read-only memory, as well as programs 127A stored in one or more of the data storage/memories 125A. The data storage/memories 125A store various data, including lighting device configuration information 128A or one or more configuration files containing such information, in addition to the illustrated programming 127A. The host processing system 115A also includes a central processing unit (CPU), shown by way of example as a microprocessor (μP) 123A, although other processor hardware may serve as the CPU.

The ports and/or interfaces 129A couple the processor 123A to various elements of the device 11A logically outside the host processing system 115A, such as the driver system 113A, the communication interface(s) 117A and the sensor(s) 121. For example, the processor 123A by accessing programming 127A in the memory 125A controls operation of the driver system 113A and other operations of the lighting device 11A via one or more of the ports and/or interfaces 129A. In a similar fashion, one or more of the ports and/or interfaces 129A enable the processor 123A of the host processing system 115A to use and communicate externally via the interfaces 117A; and the one or more of the ports 129A enable the processor 123A of the host processing system 115A to receive data regarding any condition detected by a sensor 121A, for further processing.

In the examples, based on its programming 127A, the processor 123A processes data retrieved from the memory 123A and/or other data storage, and responds to light output parameters in the retrieved data to control the light generation and distribution system 111A. The light output control also may be responsive to sensor data from a sensor 121A. The light output parameters may include light intensity and light color characteristics in addition to spatial modulation (e.g. steering and/or shaping and the like for achieving a desired spatial distribution).

As noted, the host processing system 115A is coupled to the communication interface(s) 117A. In the example, the communication interface(s) 117A offer a user interface function or communication with hardware elements providing a user interface for the device 11A. The communication interface(s) 117A may communicate with other control elements, for example, a host computer of a building control and automation system (BCAS). The communication interface(s) 117A may also support device communication with a variety of other systems of other parties, e.g. the device manufacturer for maintenance or an on-line server for downloading of virtual luminaire configuration data.

As outlined earlier, the host processing system 115A also is coupled to the driver system 113A. The driver system 113A is coupled to the light source 110A and the spatial modulator 111A to control one or more operational parameter(s) of the light output generated by the source 110 A and to control one or more parameters of the modulation of that light by the spatial modulator 111A. Although the driver system 113A may be a single integral unit or implemented in a variety of different configurations having any number of internal driver units, the example of system 113A may include a separate general illumination device and a spatial modulator driver circuit (not shown) and a separate image display driver (not shown). The separate drivers may be circuits configured to provide signals appropriate to the respective type of light source and/or modulators of the general illumination device 111A utilized in the particular implementation of the device 11A, albeit in response to commands or control signals or the like from the host processing system 115A.

The host processing system 115A and the driver system 113A provide a number of control functions for controlling operation of the lighting device 11A. In a typical example, execution of the programming 127A by the host processing system 115A and associated control via the driver system 113A configures the lighting device 11 to perform functions, including functions to operate the light source 110A to provide light output from the lighting device and to operate the spatial modulator 111A to steer and/or shape the light output from the source (not shown) so as to distribute the light output from the lighting device 11A to emulate a lighting distribution of a selected one of a number of types of luminaire, based on the lighting device configuration information 128A.

Apparatuses implementing functions like those of device 11A may take various forms. In some examples, some components attributed to the lighting device 11A may be separated from the controllable image generation and lighting system 111A. For example, an apparatus may have all of the above hardware components on a single hardware device as shown or in different somewhat separate units. In a particular example, one set of the hardware components may be separated from the controllable image generation and lighting system 111A, such that the host processing system 115A may run several similar systems of sources and modulators from a remote location. Also, one set of intelligent components, such as the microprocessor 123A, may control/drive some number of driver systems 113A and associated the controllable image generation and lighting system 111A. It also is envisioned that some lighting devices may not include or be coupled to all of the illustrated elements, such as the sensor(s) 121A and the communication interface(s) 117A. For convenience, further discussion of the device 11A of FIG. 1 will assume an intelligent implementation of the device that includes at least the illustrated components.

In addition, the device 11A is not size restricted. For example, each device 11A may be of a standard size, e.g., 2-feet by 2-feet (2×2), 2-feet by 4-feet (2×4), or the like, and arranged like tiles for larger area coverage. Alternatively, the device 11A may be a larger area device that covers a wall, a part of a wall, part of a ceiling, an entire ceiling, or some combination of portions or all of a ceiling and wall.

In an operation example, the processor 123A receives a configuration file 128A via one or more of communication interfaces 117A. The configuration file 128A indicates a user selection of a virtual luminaire light distribution to be provided by the configurable lighting device 11A. The processor 123A may store the received configuration file 128A in storage/memories 125A. Each configuration file includes software control data to set the light output parameters of the software configurable lighting device at least with respect to spatial modulation. The configuration information in the file 128A may also specify operational parameters of a light source installed in the general illumination device 111A and/or the image display device 119A, such as light intensity, light color characteristic, image parameters and the like, as well as the operating state of light processing and modulation components of the controllable image generation and lighting system 111A. The processor 123A by accessing programming 127A and using software configuration information 128A, from the storage/memories 125A, controls operation of the driver system 113A, and through that system 113A controls the light source 110 and the spatial optical modulator 111A. For example, the processor 123A obtains distribution control data from a configuration file 128A, and uses that data to control the driver system 113A to cause the display of an image and also set operating states of the light processing and modulation components of the controllable image generation and lighting system 111A to optically, spatially modulate output of the light source 110 to produce a selected light distribution, e.g. to achieve a predetermined image presentation and a predetermined light distribution for a general illumination application of a luminaire.

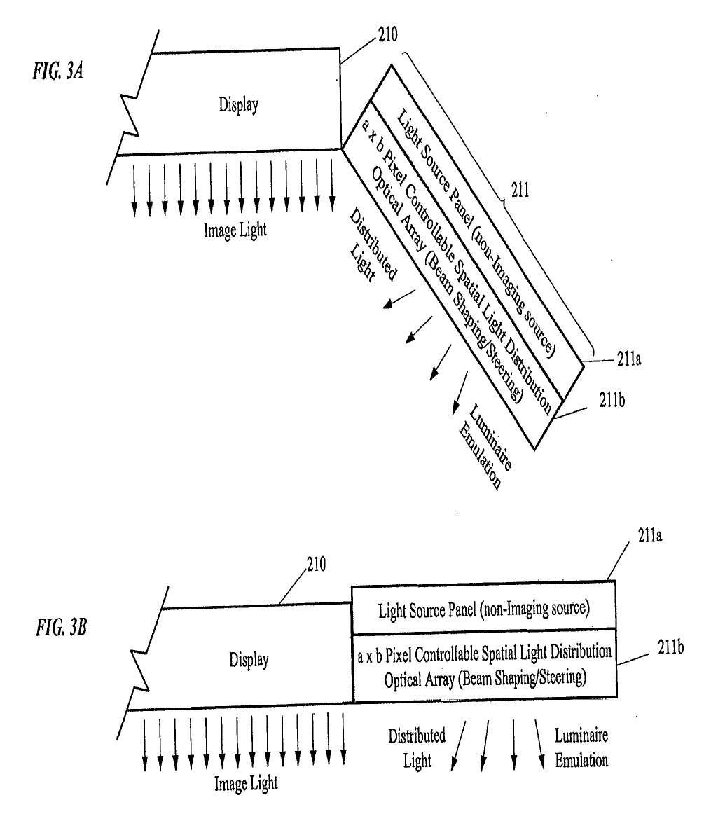

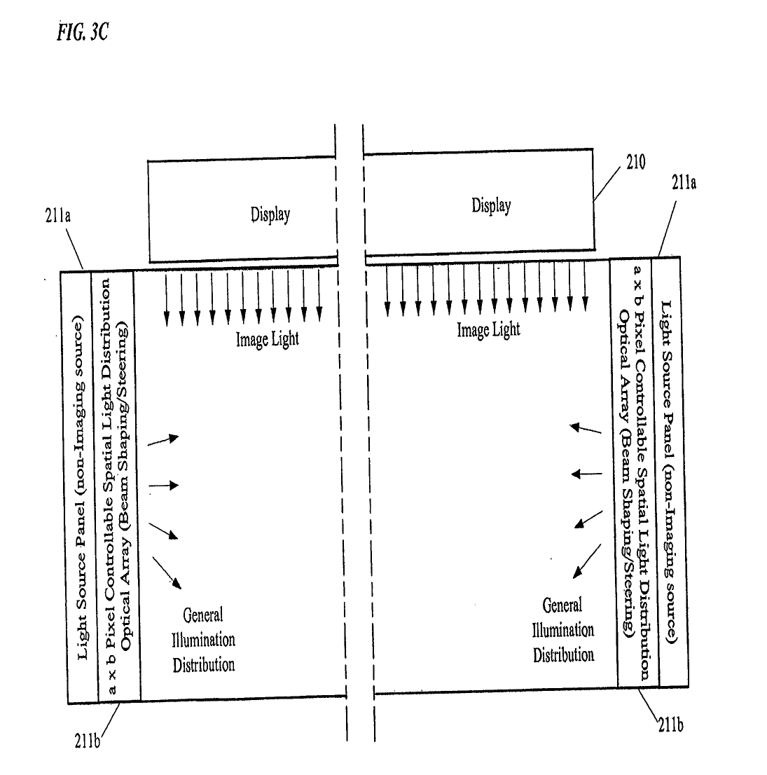

Lighting equipment like that disclosed the examples of FIGS. 1, 2 and 3A-3C may be used in combinations of a display device with other light sources, e.g. as part of the same fixture for general illumination, but not part of the same display device. Although the display device and general illumination device may be of any of the various respective types described here, for discussion purposes, we will use an example of a fixture that has a display combined with a general illumination device, i.e., a controllable additional light source. For this purpose, FIG. 2 is a plan view of a display device 200A, enhanced by combination thereof with elements 221A of a general illumination device each having one or more additional sources and/or controllable optics. As will be discussed with respect to the more specific examples of FIGS. 3A and 3B, each of the added sources of the general illumination device is a light source panel, and each of the spatial modulators may be a pixelated spatial modulator array (compare to FIG. 2).

Referring to FIG. 2, the lighting device 200 may be a panel design providing an image display device 210 with a general illumination device or elements 211 collocated with, e.g., about the perimeter, or on one or more sides or portions, of, the display device 210. The additional illumination device/elements 211, in an example, is configured from an array of light sources, such as light sources 221 and 222. The light sources 221, 222 may be arranged around the periphery of the display device 210. In one or more examples, the general illumination device 211 may include one or more light sources, such as 221 and/or 222, that surround the image display device 210, or is collocated at a portion of the periphery of the image display device 210. In other examples, the general illumination device 211 is a number of individually controllable light sources, such as 221 or 222, located on at least one side of the image display device 210. In yet another alternative arrangement, the light sources 221, 222 may be positioned in openings through the display device. For example, the light sources 221, 22 may be punched through or physically interlaced (e.g., in a checkerboard pattern) through the display device 210.

As shown, the light sources may be comprised of single light sources, such as 221, which may have some preset beam steering or beam shaping 231 that in combination with other light sources provides a predetermined general illumination light distribution. Alternatively, the light sources may include a number of light sources, such as 222, packaged to provide general illumination light in a dispersed or focused distribution as predetermined when the illumination area/elements 211 is fabricated. The light sources 223, 225, and 227 are shown with TIR-like lens structures that direct light output from the emitters EM with a predetermined beam shape and/or beam steering distribution. While shown as TIR-like lens structures, other beam steering/beam shaping techniques or structures, such as electrowetting or microlens, may be used, such as a single lens, like a beam steering automobile headlight, that provides beam shaping and/or beam steering for the aggregate light output by the light emitters EM.

In an operational example, a driver system, such as 113A, is coupled to a processor and the general illumination device 211 to control light generated by the general illumination device 211. The processor 123A controls operation of the driver system 113A and has access to the memory 125A. The processor 123A executing programming in the memory, obtains an image selection of a luminaire and a predetermined general lighting distribution selection as software control data. The predetermined general lighting distribution selection may be limited only a few, e.g., less than 10, predetermined distribution settings depending upon the light sources used in the illumination device 211 and the location of the illumination device 211 around the periphery of the image display device 210. The processor 123A is configured to cause the image display device to present an image output based on the image selection. In addition, the processor 123A controls operation of the general illumination device via the driver system 113A to emit light for general illumination from the general illumination device according to the general lighting distribution selection.

The illumination device 211 may also be a controllable spatial light distribution optical array for processing the emitted light according to the general lighting distribution selection. To explain in more detail by way of example, the illumination device 211 may receive control signals from the driver system 113A that control beam steering/beam shaping element 231 to process light with a particular beam steering and/or beam shaping process to provide one of the selected, predetermined general lighting distribution. Alternatively, in examples of a lighting device 200 that is implemented using light sources such as 222, the driving system 113A may provide control signals that individually turn ON specific individual light source elements, such as 223, 225, 227 within the light source 222. Each of the individual light sources 223, 225 and 227 may include an light emitter EM with an integrated lens or the like. For example, the control signals provided the driving system 113A may only turn on light source element 227, which provides an angled light distribution, while control signals that turn on all of light sources elements 223, 225, 227 cause the generation of a more dispersive light distribution. Of course, the driver system 113A can provide control signals that turn ON individual light source elements 223, 225, 227 within a respective light source 222 for each of the light sources 222 that make up the illumination device 222. For example, if 5,000 individual light sources 222 are used in the illumination device 211, the driver system 113A may generate control signals for each of the 5,000 individual light sources 222. In another example, the control signals may be provided for each of the individual light elements 223, 225, 227 of each of the 5,000 individual light sources 222. Or, in other words, the array of light sources includes a number of individually controllable spatial light distribution elements.

In the example of FIG. 2, the image display device 210 may be a display device that is an organic light emitting diode display device, non-organic light emitting diode display device, a plasma display device, and a liquid crystal display device.

As shown in the cross-sectional views of FIGS. 3A and 3B, each of the general illumination devices 211 is formed by a combination of a light source panel 211a and a spatial light distribution optical array 211b. Each combination of a light source panel 211a and a spatial light distribution optical array 211b operates and is controlled essentially as described by way of example above, to produce a distributed light output suitable for general illumination.

In the example of FIGS. 2 to 3B, the image light and/or general illumination light from the display device 210 provides an image visible to a person within the space in which the lighting device 200 is installed. The intensity and/or color characteristics of the image and/or light output of the display device 210 may be selectively controlled, however, there is no direct spatial modulation of image light. Light, however, is additive. The light output general illumination device 211 are selectively modulated. Hence, in an example like that shown in FIGS. 2 to 3B, the combination of light from the display and light from the modulated distributed light outputs from the spatial modulation elements 305 can be controlled to emulate a lighting distribution of a selected one of a variety of different luminaries.

The light source panel 211a and spatial light distribution optical array 211b forming each genital illumination device 211 may be positioned at any desired angle relative to the output surface or aperture of the display device. FIG. 3A, for example, illustrates an arrangement in which the light source panel 211a and spatial light distribution optical array 211b are mounted with their emission surfaces/apertures at an obtuse angle relative to the plane of the output surface or aperture of the display device 210. In such an arrangement, an observer looking at the fixture 200 would see a plan view (like FIG. 2) in which the spatial modulation elements 211b appear as additional emission sources along the edges of the display device 210. As an alternative example, FIG. 3B illustrates an arrangement in which the light source panel 211a and spatial light distribution optical array 211b are mounted with their emission surfaces/apertures approximately perpendicular to the plane of the output surface or aperture of the display device 210. In such an arrangement, an observer looking at the fixture 200 would mainly see the output surfaces of the spatial modulation elements 211b along the edges of the display device 210 in a plan type view similar to FIG. 2.

In yet another alternative example, FIG. 3C illustrates an arrangement in which the light source panel 211a and spatial light distribution optical array 211b are mounted with their emission surfaces/apertures approximately perpendicular to the plane of the output surface or aperture of the display device 210. In such an arrangement, an observer looking at the fixture 200 would mainly see the end surfaces of light source panel 211a and end surfaces of the spatial modulation elements 211b along the edges of the display device 210 in a plan type view similar to FIG. 2.

The general illumination device 211 may abut or adjoin the respective edge(s) of the display device 210, as illustrated by way of example in FIG. 3A. For some general lighting applications, however, the general illumination device 211 may be separated somewhat from the respective edge(s) of the display device 210, as illustrated by way of example in FIG. 3A or 3C.

In the examples we have been considering so far, a processor, such as 123A configures the lighting device 11A to provide light output from the display device 111A and to operate the general illumination device 119A to provide general illumination that substantially emulates a lighting distribution of a selected one of a number of types of luminaire, based on the lighting device configuration information.

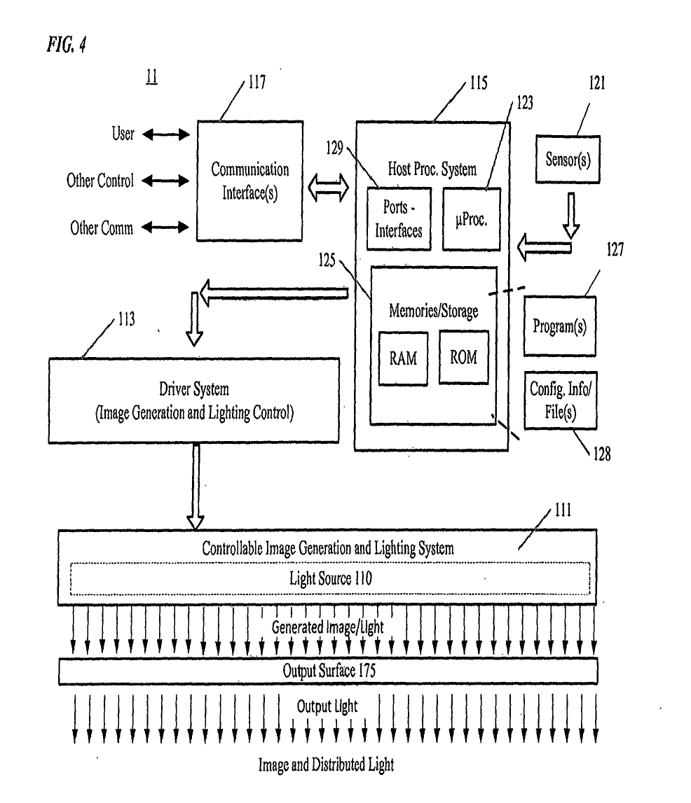

As described herein, a software configurable lighting device 11A (e.g. FIG. 1) or 11 (e.g. FIG. 4) of the type described herein can store configuration information for one or more luminaire output distributions. A user may define the parameters of a distribution in the lighting device 11/11A, for example, via a user interface on a controller or user terminal (e.g. mobile device or computer) in communication with the software configurable the lighting device 11/11A. In another example, the user may select or design a distribution via interaction with a server, e.g. of a virtual luminaire store; and the server communicates with the software configurable the lighting device 11/11A to download the configuration information for the selected/designed distribution into the lighting device 11/11A. When the software configurable lighting device 11/11A stores configuration information for a number of lighting distributions, the user operates an appropriate interface to select amongst the distributions available in the software configurable the lighting device 11/11A. Selections can be done individually by the user from time to time or in an automatic manner selected/controlled by the user, e.g. on a user's desired schedule or in response to user selected conditions such as amount of ambient light and/or number of occupants in an illuminated space.

Other configurations of the lighting device 11A are also envisioned. For example, a lighting device incorporating an enhanced display and/or additional lighting source within the image display device is illustrated in FIG. 4. FIG. 4 illustrates a high-level functional block diagram of a software configurable lighting device 11, including a driver system 113 and means for providing an enhanced display capable of providing general illumination according to building codes and/or industry standards, in this first example, in the form of a controllable image generation and lighting system 111 and an output surface 175. The structure of and the connections between elements 115A, 123A and 125A-129A in FIG. 1 are substantially the same as the similarly numbered elements of FIG. 4; therefore, a detailed description is not provided with reference all of the elements of FIG. 4. In more detail, the enhanced display lighting device 11 of FIG. 4 differs from the enhanced display lighting device 11A of FIG. 1 in that the individual image display device 119A and a controllable lighting system 111A is replaced with a combined controllable image generation and lighting system 111.

The controllable image generation and lighting system 111, in this example, includes an enhanced lighting source 110. The controllable image generation and lighting system 111 is an enhanced display device. Although virtually any source of artificial light may be used as the source 110, in the examples, the source 110 typically is light source, used in the generation of an image that is to be presented at the output surface 175 of the display, but that also provides sufficient light output that the controllable image generation lighting system 175 acts as lighting device servicing the area in which the lighting device 11 is installed. A variety of suitable light generation sources are indicated below.

Examples of the light source 110 include various conventional lamps, such as incandescent, fluorescent or halide lamps; one or more light emitting diodes (LEDs) of various types, such as planar LEDs, micro LEDs, micro organic LEDs, LEDs on gallium nitride (GaN) substrates, micro nanowire or nanorod LEDs, photo pumped quantum dot (QD) LEDs, micro plasmonic LED, micro resonant-cavity (RC) LEDs, and micro photonic crystal LEDs; as well as other sources such as micro super luminescent Diodes (SLD) and micro laser diodes. Of course, these light generation technologies are given by way of non-limiting examples, and other light generation technologies may be used to implement the source 110. In particular, the light source 110 is an enhanced light source that generates outputs lumens greater than a standard LCD or plasma display. For example, a 48″ flat-panel LCD typically outputs about 500 lumens which is less than (<) 10% of lumen output from a typical 2′×4′ troffer type luminaire, which is of comparable size to the 48″ flat-panel LCD display.

In the examples, the light source 110 is a type of light source that provides light for illumination and also provides a perceptible image display when the output surface 175 or the device 11 is viewed directly by an observer. The source 110 may use a single emitter to generate light, or the source 110 may combine light from some number of emitters that generate the light. A lamp or ‘light bulb’ is an example of a single source, an LED light engine provide a single combine output for a single source but typically combines light from multiple LED type emitters within the single engine. Many types of light sources provide an illumination light output that generally appears uniform to an observer, although there may be some color or intensity striations, e.g. along an edge of a combined light output. For purposes of the present examples, however, the appearance of the light source output may not be strictly uniform across the output area or aperture of the source 110. For example, although the source 110 may use individual emitters or groups of individual emitters to produce the light generated by the overall source 110; depending on the arrangement of the emitters and any associated mixer or diffuser, the light output may be relatively uniform across the aperture or may appear pixelated to an observer viewing the output aperture. The individual emitters or groups of emitters may be separately controllable, for example to control intensity or color characteristics of the source output. As such, the source 110 may or may not be pixelated for control purposes.

A variety of light processing and modulation techniques may be used (or used in combination) to implement the controllable image generation and lighting system 111. Examples of controllable optical processing and modulators that may be used as the controllable image generation and lighting system 111 or other modulator means include the LCD control systems typically found in an LCD-type display device as well as holographic films, and switchable diffusers and/or gratings based on LCD materials. Of course, these modulation technologies are given by way of non-limiting examples, and other modulation techniques may be used to implement the controllable image generation and lighting system 111.

For convenience, FIG. 4 shows an arrangement of the controllable image generation and lighting system 111 that corresponds most closely to use of an enhanced light source 110 and modified components of a display device (which will be described in more detail with reference to the other examples illustrated herein) transmissive type modulator, where the modulator passes light through but modulates distribution of the transmitted light.

The description also mentions a variety of suitable modifications to existing display technologies that take advantage of the enhanced lighting source 110, and several examples of light processing techniques are described in detail and illustrated in later drawings. The types of light processing components chosen for use with a particular light source 110 in the controllable image generation and lighting system 111 enables the controllable image generation and lighting system 111 to optically process and manipulate the light output from the source 110 to distribute the light output from the lighting device 11 to provide a lighting distribution of a predetermined number of different types of luminaire for a general illumination application of a selected type of luminaire. In other words, the controllable image generation and lighting system 111 with the enhanced light source 110 is configured with a predetermined lighting distribution, or a predetermined range of lighting distribution adjustments, suitable for installation in a particular space, such as a retail store location or an office complex. As referred to herein, general illumination lighting is light output by the lighting device 11 that complies with governmental building codes and/or lighting industry standards for the space(s) in which the lighting device is to be installed.

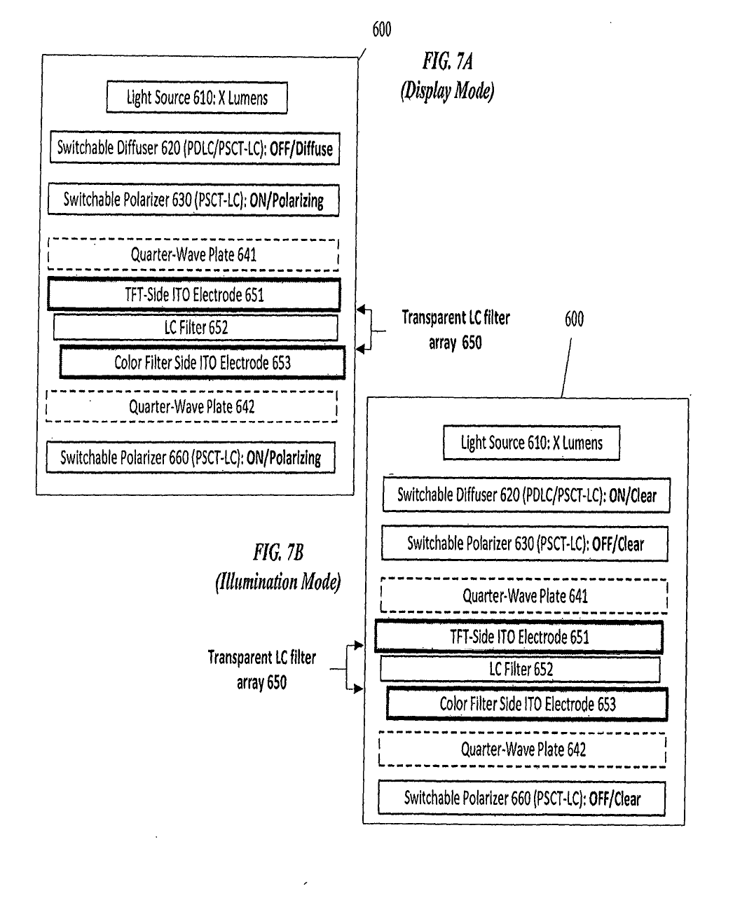

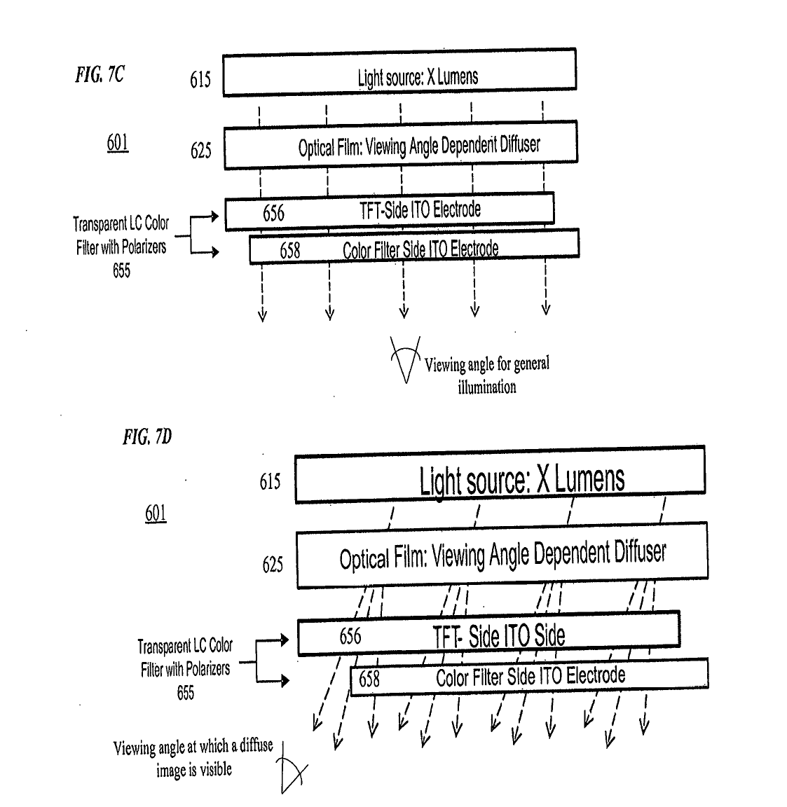

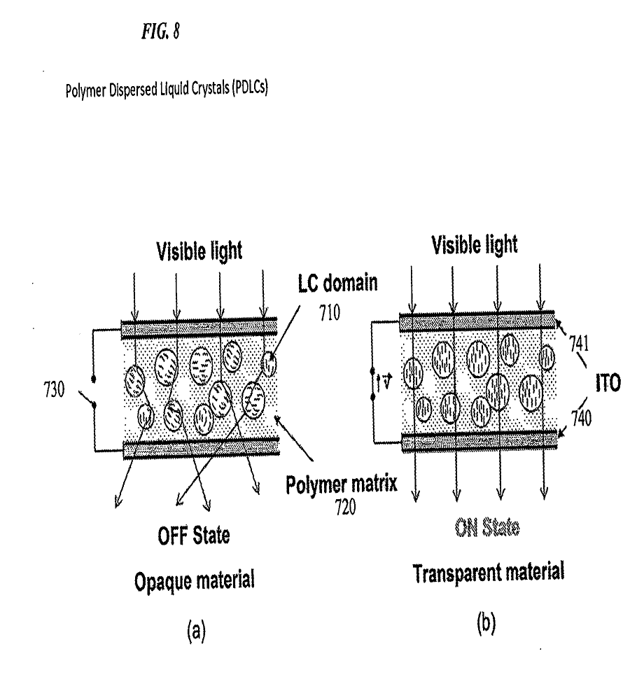

In an example, the controllable image generation and lighting system 111 may be a display device in which the enhanced light source 110 acts as a backlight or edge light via a coupling structure (not shown). In response to control signals from the driver 113, the display device of the controllable image generation and lighting system 111 may generate an image over the entire output surface of the display device, generate general illumination lighting over the entire output surface of the display device, or control some pixels of the display device on an individual or group basis to output an image while other pixels of the display device are controlled to generate general illumination. Examples of operating processes and enhanced display devices suitable for use with the controllable image generation and lighting system 111 will be described in more detail with reference to the examples of FIGS. 7A-16.

In an operational example of the lighting device 11 of FIG. 4, the processor 123 receives a configuration file 128 via one or more of communication interfaces 117. The configuration file 128 indicates a user selection of a virtual luminaire light distribution to be provided by the configurable lighting device 11. The processor 123 may store the received configuration file 128 in storage/memories 125. Each configuration file includes software control data to set the light output parameters of the software configurable lighting device at least with respect to spatial modulation. The configuration information in the file 128 may also specify operational parameters of the light source 110, such as light intensity, light color characteristic, image parameters and the like, as well as the operating state of light processing and modulation components of the controllable image generation and lighting system 111. The processor 123 by accessing programming 127 and using software configuration information 128, from the storage/memories 125, controls operation of the driver system 113, and through that system 113 controls the light source 110 and the spatial optical modulator 111. For example, the processor 123 obtains distribution control data from a configuration file 128, and uses that data to control the driver system 113 to cause the display of an image and also set operating states of the light processing and modulation components of the controllable image generation and lighting system 111 to optically, spatially modulate output of the light source 110 to produce a selected light distribution, e.g. to achieve a predetermined image presentation and a predetermined light distribution for a general illumination application of a luminaire.

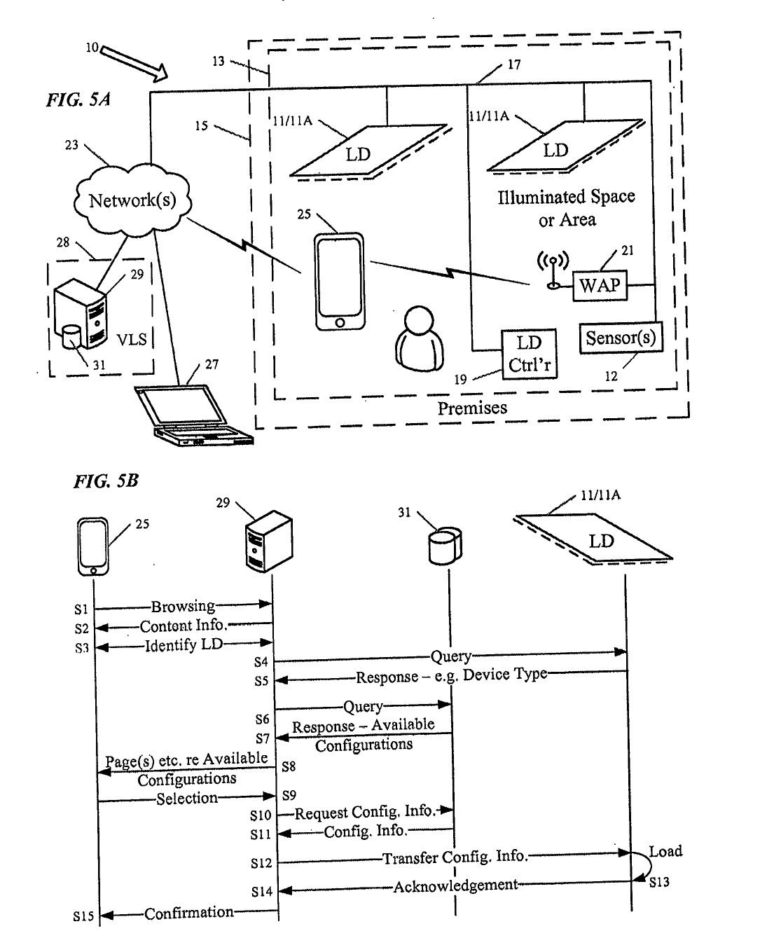

To provide examples of these methodologies and functionalities and associated software aspects of the technology, it may be helpful to consider a high-level example of a system including software configurable lighting devices 11 (FIG. 5A), and later, an example of a possible process flow for obtaining and installing configuration information (FIG. 5B).

FIG. 5A illustrates a system 10 for providing configuration or setting information, e.g. based on a user selection, to a software configurable lighting device (LD) 11 of any of the types discussed herein. For purposes of discussion of FIG. 5A, we will assume that software configurable lighting device 11 generally corresponds in structure to the block diagram illustration of a device 11 in FIG. 1.

In FIG. 5A, the software configurable lighting device 11, as well as some other elements of system 10, are installed within a space or area 13 to be illuminated at a premises 15. The premises 15 may be any location or locations serviced for lighting and other purposes by such system of the type described herein. Lighting devices, such as lighting devices 11, that are install to provide general illumination lighting in the premises 15 typically comply with governmental building codes (of the respective location of the premises 15) and/or lighting industry standards. Most of the examples discussed below focus on indoor building installations, for convenience, although the system may be readily adapted to outdoor lighting. Hence, the example of system 10 provides configurable lighting and possibly other services in a number of service areas in or associated with a building, such as various rooms, hallways, corridors or storage areas of a building and an outdoor area associated with a building. Any building forming or at the premises 15, for example, may be an individual or multi-resident dwelling or may provide space for one or more enterprises and/or any combination of residential and enterprise facilities. A premises 15 may include any number of such buildings, and in a multi-building scenario the premises may include outdoor spaces and lighting in areas between and around the buildings, e.g. in a campus (academic or business) configuration.

The system elements, in a system like system 10 of FIG. 5A, may include any number of software configurable lighting devices 11 as well as one or more lighting controllers 19. Lighting controller 19 may be configured to provide control of lighting related operations (e.g., ON/OFF, intensity, brightness) of any one or more of the lighting devices 11. Alternatively, or in addition, lighting controller 19 may be configured to provide control of the software configurable aspects of lighting device 11, as described in greater detail below. That is, lighting controller 19 may take the form of a switch, a dimmer, or a smart control panel including a user interface depending on the functions to be controlled through device 19. The lighting system elements may also include one or more sensors 12 used to control lighting functions, such as occupancy sensors or ambient light sensors. Other examples of sensors 12 include light or temperature feedback sensors that detect conditions of or produced by one or more of the lighting devices. If provided, the sensors may be implemented in intelligent standalone system elements such as shown at 12 in the drawing, or the sensors may be incorporated in one of the other system elements, such as one or more of the lighting devices 11 and/or the lighting controller 19.

The on-premises system elements 11, 12, 19, in a system like system 10 of FIG. 5A, are coupled to and communicate via a data network 17 at the premises 15. The data network 17 in the example also includes a wireless access point (WAP) 21 to support communications of wireless equipment at the premises. For example, the WAP 21 and network 17 may enable a user terminal for a user to control operations of any lighting device 11 at the premises 13. Such a user terminal is depicted in FIG. 5A, for example, as a mobile device 25 within premises 15, although any appropriate user terminal may be utilized. However, the ability to control operations of a lighting device 11 may not be limited to a user terminal accessing data network 17 via WAP 21 or other on-premises access to the network 17. Alternatively, or in addition, a user terminal such as laptop 27 located outside premises 15, for example, may provide the ability to control operations of one or more lighting devices 11 via one or more other networks 23 and the on-premises network 17. Network(s) 23 includes, for example, a local area network (LAN), a metropolitan area network (MAN), a wide area network (WAN) or some other private or public network, such as the Internet. In another example, a memory device, such as a secure digital (SD) card or flash drive, containing configuration data may be connected to one or more of the on-premises system elements 11/11A, 12 or 19 in a system like system 10 of FIG. 5A.

For lighting operations, the system elements for a given service area (11/11A, 12 and/or 19) are coupled together for network communication with each other through data communication media to form a portion of a physical data communication network. Similar elements in other service areas of the premises are coupled together for network communication with each other through data communication media to form one or more other portions of the physical data communication network at the premises 15. The various portions of the network in the service areas in turn are coupled together to form a data communication network at the premises, for example to form a LAN or the like, as generally represented by network 17 in FIG. 5A. Such data communication media may be wired and/or wireless, e.g. cable or fiber Ethernet, Wi-Fi, Bluetooth, or cellular short range mesh. In many installations, there may be one overall data communication network 17 at the premises. However, for larger premises and/or premises that may actually encompass somewhat separate physical locations, the premises-wide network 17 may actually be built of somewhat separate but interconnected physical networks utilizing similar or different data communication media.

System 10 also includes server 29 and database 31 accessible to a processor of server 29. Although FIG. 5A depicts server 29 as located outside premises 15 and accessible via network(s) 23, this is only for simplicity and no such requirement exists. Alternatively, server 29 may be located within premises 15 and accessible via network 17. In still another alternative example, server 29 may be located within any one or more system element(s), such as lighting device 11, lighting controller 19 or sensor 12. Similarly, although FIG. 5A depicts database 31 as physically proximate server 29, this is only for simplicity and no such requirement exists. Instead, database 31 may be located physically disparate or otherwise separated from server 29 and logically accessible by server 29, for example via network 17.

Database 31 is a collection of configuration information files for use in conjunction with one or more of software configurable lighting devices 11 in premises 15 and/or similar devices 11 of the same or other users at other premises. For example, each configuration information file within database 31 includes lighting device configuration information to operate the modulator of a lighting device 11 to steer and/or shape the light output from the light source to distribute the light output from the lighting device 11 to emulate a lighting distribution of a selected one of a number of types of luminaire. In many of the examples of the software configurable lighting device 11, the controllable optical modulator is configured to selectively steer and/or selectively shape the light output from the source responsive to one or more control signals from the programmable controller. The distribution configuration in a configuration information file therefore will provide appropriate setting data for each controllable parameter, e.g. selective beam steering and/or selective shape.

For some examples of the software configurable lighting device 11, the controllable optical modulator is essentially a single unit coupled/configured to modulate the light output from the emission aperture of the light source. In such an example, the distribution configuration in a configuration information file provides setting(s) appropriate for the one optical spatial modulator. In other examples of the software configurable lighting device 11, the controllable optical modulator has sub units or pixels that are individually controllable at a pixel level for individually/independently modulating different portions of the light emission from the overall output aperture of the light source. In such an example, the distribution configuration in a configuration information file provides setting(s) appropriate for each pixel of the pixel-level controllable spatial modulator.

The light source of a software configurable lighting device 11 could be a display type element, in which case a configuration information file could provide an image for output via the display. In examples for a general illumination light source, the configuration information file need not include any image-related information. In many cases, however, the configuration information file may include values for source performance parameter settings, e.g. for maximum or minimum intensity, dimming characteristics, and/or color characteristics such as color temperature, color rending index, R9 value, etc. In other cases, it is envisioned that the configuration file includes algorithms that determine source performance parameter settings including image generation settings. The algorithms may be Fourier-based or chaotic function-based for generating the image data. The general illumination may be based on algorithms for the luminaire manufacturer specifications or requirements.

The software configurable lighting device 11 is configured to set modulation parameters for the spatial modulator and possibly set light generation parameters of the light source in accordance with a selected configuration information file. That is, a selected configuration information file from the database 31 enables software configurable a lighting device 11 to achieve a performance corresponding to a selected type of luminaire for a general illumination application of the particular type of luminaire. Thus, the combination of server 29 and database 31 represents a “virtual luminaire store” (VLS) 28 or a repository of available configurations that enable a software configurable lighting device 11 to selectively function like any one of a number of luminaries represented by the available configurations.

It should be noted that the output performance parameters need not always or precisely correspond optically to the emulated luminaire. For a catalog luminaire selection example, the light output parameters may represent those of one physical luminaire selected for its light characteristics whereas the distribution performance parameters may be those of a different physical luminaire or even an independently determined performance intended to achieve a desired illumination effect in area 13. The light distribution performance, for example, may conform to or approximate that of a physical luminaire or may be an artificial construct for a luminaire not ever built or offered for sale in the real world.

It should also be noted that, while various examples describe loading a single configuration information file onto a software configurable lighting device 11, this is only for simplicity. Lighting device 11 may receive one, two or more configuration information files and each received file may be stored within lighting device 11. In such a situation, a software configurable lighting device 11 may, at various times, operate in accordance with configuration information in any selected one of multiple stored files, e.g. operate in accordance with first configuration information during daylight hours and in accordance with second configuration information during nighttime hours or in accordance with different file selections from a user operator at different times. Alternatively, a software configurable lighting device 11 may only store a single configuration information file. In this single file alternative situation, the software configurable lighting device 11 may still operate in accordance with various different configuration information, but only after receipt of a corresponding configuration information file which replaces any previously received file(s).

An example of an overall methodology will be described later with respect to FIG. 5B. Different components in a system 10 like that of FIG. 5A will implement methods with or portions of the overall methodology, albeit from somewhat different perspectives. It may be helpful at this point to discuss, at a high level, how various elements of system 10 interact to allow a lighting designer or other user to select a particular image and performance parameters to be sent to software configurable lighting device 11.

In one example, the user utilizes mobile device 25 or laptop 27 to access virtual luminaire store 28 provided on/by server 29 and database 31. Although the examples reference mobile device 25/laptop 27, this is only for simplicity and such access may be via LD controller 19 or any other appropriate user terminal device. Virtual luminaire store 28 provides, for example, a list or other indication of physical or virtual luminaries that may be emulated either by software configurable lighting devices 11 generally and/or by a particular software configurable lighting device 11. Virtual luminaire store 28 also provides, for example, a list or other indication of potential performance parameters under which software configurable lighting devices generally and/or lighting device 11 particularly may operate. Alternatively, or in addition, virtual luminaire store 28 may allow the user to provide a customized modulation and/or light performance parameters as part of the browsing/selection process. As part of the browsing/selection process, the user, for example, may identify the particular software configurable lighting device 11 or otherwise indicate a particular type of software configurable lighting device for which a subsequent selection relates. In turn, virtual luminaire store 28, for example, may limit what is provided to the user device (e.g., the user is only presented with performance parameters for luminaire emulations supportable by to the particular software configurable lighting device 11). The user, as part of the browsing/selection process, selects desired performance parameters to be sent to a particular software configurable lighting device 11. Based on the user selection, server 29 transmits a configuration information file containing configuration information corresponding to the selected parameters to the particular software configurable lighting device 11.

It may also be helpful to discuss, at a high level, how a software configurable lighting device 11 interacts with other elements of system 10 to receive a file containing configuration information and how the software configurable lighting device 11 utilizes the received file to operate in accordance with performance parameters specified by the lighting device configuration information from the file. In a method example from the device-centric perspective, the software configurable lighting device 11 receives a configuration information file via network 17, such as the configuration information file transmitted by server 29 in the previous example. The received configuration information file includes, for example, data to set the light output parameters of software configurable lighting device 11 with respect to spatial modulation and possibly with respect to light intensity, light color characteristic and the like. Lighting device 11 stores the received configuration file, e.g. in a memory of lighting device 11. In this further example, the software configurable lighting device 11 sets light output parameters in accordance with the data included in the configuration information file. In this way, lighting device 11 stores the received file and can utilize configuration information contained in the file control the light output distribution performance of software configurable lighting device 11 and possibly light output characteristics of the device 11.

The lighting device configuration information in a configuration file may correspond to performance of an actual physical luminaire, e.g. so that the software configurable lighting device 11 presents an illumination output for a general lighting application having a distribution and possibly light characteristics (e.g. intensity and color characteristic) approximating those of a particular physical lighting device of one manufacturer. The on-line store implemented by server 29 and database 31 in the example of FIG. 4B therefore would present content showing and/or describing a virtual luminaire approximating the performance of the physical lighting device. In that regard, the store may operate much like the manufacturer's on-line catalog for regular lighting devices allowing the user to browse through a catalog of virtual luminaire performance characteristics, many of which represent corresponding physical devices. However, virtual luminaire store 28 may similarly offer content about and ultimately deliver information defining the visible performances of other virtual luminaries, e.g. physical lighting devices of different manufacturers, or of lighting devices not actually available as physical hardware products, or even performance capabilities that do not emulate otherwise conventional lighting devices.

Virtual luminaire store 28 allows a lighting designer or other user to select from any such available luminaire performance for a particular luminaire application of interest. Virtual luminaire store 28 may also offer interactive on-line tools to customize any available luminaire performance and/or interactive on-line tools to build an entirely new luminaire performance for implementation via a software configurable lighting device 11.

The preceding examples focused on selection of one set of lighting device configuration information, for the luminaire performance characteristics. Similar procedures via virtual luminaire store 28 will enable selection and installation of one or more additional sets of lighting device configuration information, e.g. for use at different times or for user selection at the premises (when the space is used in different ways).

FIG. 5B is a Ping-Pong chart type signal flow diagram, of an example of a procedure for loading lighting device configuration information to a software configurable lighting device 11/11A, in a system like that of FIG. 5A. In an initial step S1, a user browses virtual luminaire store 28. For example, a user utilizes mobile device 25 to access server 29 and reviews various luminaries or luminaire performances available in the virtual luminaire store, as represented by configuration information files. Although mobile device 25 is referenced for simplicity in some examples, such access may be achieved by the user via laptop 27, LD controller 19 or other user terminal device. If the device 11/11A has appropriate user input sensing capability, access to store 28 may alternatively use device 11/11A. In step S2, virtual luminaire store 28 presents information about available virtual luminaries to the user. The content may be any suitable format of multimedia information about the virtual luminaries and the performance characteristics, e.g., text, image, video or audio. While steps S1 and S2 are depicted as individual steps in FIG. 4B, no such requirement exists and this is only for simplicity. Alternatively, or in addition, steps S1 and S2 may involve an iterative process wherein the user browses a series of categories and/or sub-categories and virtual luminaire store 28 provides the content of each category and/or sub-category to the user. That is, steps S1 and S2 represent the ability of a user to review data about some number of virtual luminaries available in virtual luminaire store 28 for configuring a software configurable lighting device.

In step S3, the user identifies a particular software configurable lighting device 11/11A for which a selected configuration information file is to be provided. For example, if the space or area 13 to be illuminated is the user's office, the user identifies one of several lighting devices 11/11A located in the ceiling or on a wall of that office. In step S4, server 29 queries the particular lighting device 11/11A through the network(s) to determine a device type, and the particular lighting device 11/11A responds with the corresponding device type identification.

In one example, software configurable lighting devices 11/11A include 3 different types of lighting devices. Each different lighting device, for example, utilizes a different spatial distribution system 111, possibly a different type of light source 110, and a different associated driver system 113. In such an overall example, each of the 3 different types of lighting devices 11/11A may only be configured to provide performance for some number of available virtual luminaire performance characteristics (e.g., different virtual luminaire output distributions and possibly different virtual luminaire output light parameters, such as intensity and color characteristics). In a three-device-type example, assume device type 1 supports X sets of virtual luminaire performance characteristics, device type 2 supports Y sets of virtual luminaire performance characteristics and device type 2 supports Z sets of virtual luminaire performance characteristics. Thus, in this example, server 29 queries lighting device 11/11A in step S4 and lighting device 11, in step S5, responds with device type 1, for example.

In step S6, server 29 queries database 31 to identify available sets of virtual luminaire performance characteristics supported by the particular lighting device 11/11A. Such query includes, for example, the device type of the particular lighting device 11/11A. In step S7, the database responds with available sets of virtual luminaire performance characteristics supported by the particular lighting device 11/11A. For example, if particular lighting device 11/11A is of device type 1, then database 31, in step S7, responds with device type 1 available sets of virtual luminaire performance characteristics. In step S8, server 29 provides corresponding information to the user about those available sets of virtual luminaire performance characteristics supported by particular lighting device 11/11A.

Thus, steps S3-S8 allow a user to be presented with information about performance parameter sets for only those virtual luminaries supported by the particular software configurable lighting device 11/11A that the user is attempting to configure. However, these steps are not the only way for identifying only those sets of virtual luminaire performance characteristics supported by a particular lighting device. In an alternate example, the user may identify the device type as part of step S3 and server 29 may proceed directly to step S6 without performing steps S4-S5.

In still another example, the user may identify the particular software configurable lighting device 11/11A, either with or without a device type, in an initial step (e.g., perform step S3 before step S1). In this way, steps S1 and S2 only include information about performance parameter sets for those available virtual luminaries supported by the identified lighting device 11/11A; and step S8 need not be performed as a separate step. In other words, steps S1-S8 represent only one example of how information describing available virtual luminaries in virtual luminaire store 28 are presented to a user for subsequent selection.

The user, in step S9, utilizes mobile device 25 to select information about a performance parameter set for a desired virtual luminaire lighting application from among the available virtual luminaire performance characteristics previously presented. For example, if the user desires a luminaire performance from device 11/11A analogous to performance of a particular can light with downlighting, and the performance for the desired can downlight is supported by lighting device 11/11A, the user selects the virtual luminaire performance characteristics for the desired can downlight in step S9.

While the descriptions of various examples most commonly refer to information about a single virtual luminaire or selection of information about a single virtual luminaire, this is only for simplicity. The virtual luminaire store described herein allows a user to separately select each of the image to be displayed by a software configurable lighting device and the set of performance parameters to control illumination produced by that software configurable lighting device 11/11A. As such, although not explicitly depicted in FIG. 5B or described above in relation to steps S1-S9, the user, for example, may select some of the performance characteristics for a desired first virtual luminaire lighting application corresponding to one type of luminaire, e.g. intensity and light color characteristics and select other performance parameters corresponding to a different virtual luminaire, e.g. shape and/or steering for beam light output distribution, as part of step S9. Alternatively, or in addition, the virtual luminaire store 28 may also allow the user to define or otherwise customize the set of performance parameters to be delivered to the software configurable lighting device 11/11A.

In step S10, server 29 requests the corresponding information about the selected set of performance parameters from database 31 in order to obtain a corresponding configuration information file. Database 31, in step S11, provides the requested information to server 29. As noted previously, a software configurable lighting device 11/11A may be one particular type of multiple different types of software configurable lighting devices usable in systems such as 10 and supported by the virtual luminaire store 28. The selected configuration information may be different for each different type of software configurable lighting device (e.g., a first type device 11/11A may support light output distribution of one format while a second type device 11/11A may not support the same light output distribution format, a first type device 11/11A may support a first set of illumination performance parameters (intensity and/or color characteristics) while a second type device 11/11A may support a second set of illumination performance parameters). In one example, database 31 maintains different configuration information corresponding to each different type of software configurable lighting device 11/11A; and, as part of step S11, database 31 provides the appropriate corresponding configuration information. Alternatively, database 31 maintains common or otherwise standardized configuration information; and, after receiving the requested configuration information from database 31, server 29 may manipulate or otherwise process the received configuration information in order to obtain a configuration information file more specifically corresponding to the type of the particular lighting device 11 intended to currently receive the configuration information. In this way, server 29 obtains a file of suitable configuration information including information about the selected set of performance parameters.

Server 29, in step S12, transfers the configuration information file to the particular software configurable lighting device 11/11A. For example, the server 29 utilizes network(s) 23 and/or network 17 to communicate the configuration information file directly to the software configurable lighting device 11/11A. Alternatively, or in addition, the server 29 may deliver the configuration information file to a user terminal (e.g., mobile device 25 or laptop 27) and the user terminal may, in turn, deliver the file to the software configurable lighting device 11/11A. In still another example, the server 29 transfers the configuration information file to LD controller 19 which, in turn, uploads or otherwise shares the configuration information file with the software configurable lighting device 11/11A.

In step S13, the software configurable lighting device 11/11A receives the configuration information file and stores the received file in memory (e.g., storage/memory 125). Once lighting device 11/11A has successfully received and stored the selected configuration information file, the software configurable lighting device 11/11A provides an acknowledgement to server 29 in step S14. In turn, server 29 provides a confirmation of the transfer to the user via mobile device 25 in step S15. In this way, a user is able to select a desired virtual luminaire performance from a virtual luminaire store and have the corresponding configuration information file delivered to the identified lighting device 11/11A.

While the discussion of FIG. 5B focused on delivering a single configuration information file to a single software configurable lighting device 11/11A, this is only for simplicity. The resulting configuration information file may be delivered to one or more additional lighting devices 11/11A in order to implement the same configuration on the additional lighting devices. For example, a user may elect to have steps S13-S15 repeated some number of times for a corresponding number of additional software configurable lighting devices. Alternatively, or in addition, the various steps of FIG. 5B may be repeated such that different configuration information files are delivered to different software configurable lighting devices 11/11A. As such, a single configuration information file may be delivered to some number of software configurable lighting devices while a different configuration information file is delivered to a different number of lighting devices and still another configuration information file is delivered to yet a further number of lighting devices. In this way, the virtual luminaire store 28 represents a repository of sets of virtual luminaire performance characteristics which may be selectively delivered to utilized by one or more software configurable lighting devices 11/11A.

Other aspects of the virtual luminaire store not shown may include accounting, billing and payment collection. For example, virtual luminaire store 28 may maintain records related to the type and/or number of configuration information files transmitted to software configurable lighting devices 11/11A at different premises 15 and/or owned or operated by different customers. Such records may include a count and/or identifications of different lighting devices receiving configuration information files, a count of how many times the same lighting device receives the same or a different configuration information file, a count of times each set of virtual luminaire performance characteristics is selected, as well as various other counts or other information related to selection and delivery of configuration information files. In this way, virtual luminaire store 28 may provide an accounting of how the store is being utilized.

In a further example, a value is associated with each configuration information file or each component included within the file (e.g., a value associated with each set of spatial modulation or distribution type performance parameters and/or a value associated with each set of light output performance parameters). The associated value may be the same for all configuration information files (or for each included component), or the associated value may differ for each configuration information file (or for each included component). While such associated value may be monetary in nature, the associated value may alternatively represent non-monetary compensation. In this further example, virtual luminaire store 28 is able to bill for each transmitted configuration information file (or each included component); and the operator of the store can collect payment based on a billed amount. In conjunction with the accounting described above, such billing and payment collection may also vary based on historical information (e.g., volume discount, reduced value for subsequent transmission of the same configuration information file to a different lighting device, free subsequent transmission of the same configuration information file to the same lighting device, etc.). In this way, virtual luminaire store 28 may allow an individual or organization operating the store to capitalize on the resources contained within the store.

As noted earlier, the software configurable lighting devices under consideration here can utilize a variety of technologies to implement the enhanced displays described herein. It may be helpful, however, to consider conventional liquid crystal display (LCD) technology before discussing the enhanced lighting device display technology described herein.

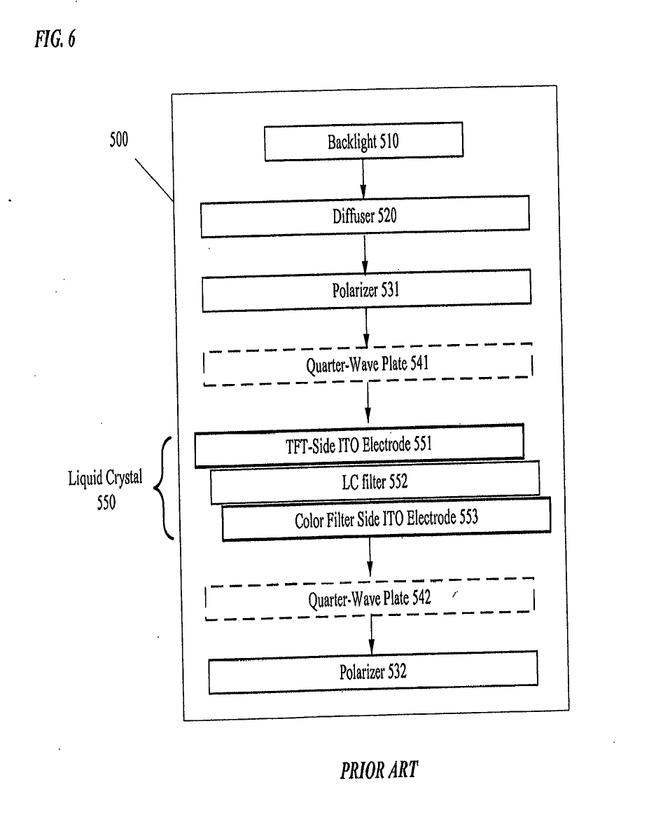

Substantially all LCDs operate as light switches, able to control light intensity and color but with almost no other ability to change the beam shape of incident light. As mentioned in the background, current LCD devices, such as the prior art liquid crystal display LCD 500 shown in FIG. 6, have a number of layers. Conventional LCDs operate by using liquid crystals (LCs) to modulate the polarization state of light. The LCD 500 includes a suitable backlight 510, which supplies input light to a multi-layered stack that includes the actual liquid crystal (LC) layer 550. The backlight 510 of the conventional LCD device is presently limited to generating light having a lumen output based on the dimensions of the LCD device. For example, an LCD computer monitor backlight may output light in the range of 100s of lumens and an LCD television backlight may generate 1000s of lumens to compensate for the inefficiencies of the conventional LCD 500. The light generated by the backlight 510 is passed to a diffuser 520. The diffuser 520 collimates or conditions the backlight 510 light to provide a more uniform light distribution. The light output from the backlight 510 and the diffuser 520 is unpolarized light. The unpolarized light has no fixed electric field pattern relative to the direction of the output light. The unpolarized light output from the diffuser 520 is input to a first polarizer 531, which linearly polarizes the input light and outputs linearly polarized light.

In the LCD 500, the LC layer 550 includes electrodes 551, 553 on either side of an LC filter 552. Usually the exit electrode 553 contains red, blue, color filters to control the color of individual pixels of LCD 500. The LC filter 552 provides the brightness modulation for the individual pixels of LCD 500. The LC layer 550 is placed between two thin film, absorbing, linear polarizers 531, 532 within the stack; although the second polarizer 532 may be referred to as an analyzer. Quarter-wave plates (QWP) 541, 542 also may be provided, as shown in dashed lines in the drawing.

The polarizers 531, 532 transmit only light along their transmission axes. Hence, if the light is unpolarized (meaning electrical field direction is random), 50% of the light is transmitted since only the light parallel to the transmission axis of the given polarizer passes through the respective polarizer. In reality, this number is between 40 and 45% across the visible light range of the spectrum since part of the light is also absorbed parallel to the transmission axis due to the materials used. Typically in an LCD 500, the light transmission axes of the polarizers 531, 532 are chosen to be orthogonal to each other. When no liquid crystal layer 550 is present between them, no light is transmitted because the light transmitted by the first polarizer 531 is blocked by the orthogonal second polarizer 532.

In an LCD 500, typically the LC layer 550 is chosen such that the LC 550 accepts the linearly polarized light from the first polarizer 531 and rotates it, for example, by 90 degrees to match the transmission axis of the second polarizer 532. In this state (OFF or bright state), light is transmitted through this polarizer-LC-polarizer sandwich. By placing the LC layer 552 between transparent Indium Tin Oxide (ITO) electrode layers 551, 553 as shown in the figure, voltage can be applied by a source driver 1633 to cause the LC molecules to change their alignment. By controlling the voltages, the amount of polarization rotation caused the LC layer can be controlled from 90 degrees (No voltage) to almost 0 degrees (High Voltage ˜10-20 V) to control the amount of light from the first polarizer 531 that is shifted sufficiently to pass through the orthogonal second polarizer 532.

The output light from the LC layer 550 is “analyzed” by the second polarizer 532 (hence the term analyzer) and correspondingly blocked or passed based on degree of polarity relative to the second polarizer 532, effectively causing the light output to vary from 40% to 0% of the input light. In this manner, the sandwich of liquid crystal and polarizer layers can act as a voltage controlled light switch. Dye based Red, Blue, and Green color filters (not shown) are added to the ITO electrode on the substrate 553 as sub-pixels to control the color output of each LC “pixel”. The other ITO electrode layer on the substrate 551 has Thin Film Transistors (TFTs) within each sub-pixel for switching the voltage of each sub-pixel of the LC filter 552. Since each color filter absorbs the color of the other two types, the color filter layer efficiency is <33%.

In most conventional LCDs, the overall optical efficiency is between 5-10% of the input light remaining in the image display output with the major losses due to the color filters, polarizers, and pixel fill factors (room required for TFTs, to isolate pixels, and to route source and driver lines). The major losses in the LCD 500 are due to the color filters, polarizers, and pixel fill factors (room required for TFTs, to isolate pixels, and to route source and driver lines). Further all LCDs operate as light switches, able to control light intensity and color but with almost no other ability to change the beam shape of incident light.

A primary purpose of a conventional LCD display is to provide imagery in a manner that results in a satisfactory viewing experience of a viewer. Conversely, the lighting device display technology described herein is, first, a lighting device that provides general illumination suitable for lighting a space in a code/standard-compliant manner, and, second, a lighting device capable of providing an image. A lighting device also provides light having a particular general illumination distribution, and modifications to layers of the conventional display are also envisioned to provide the particular general illumination distribution of a lighting device.

The conventional LCD display of FIG. 6 due to poor efficacy is unable to provide general illumination as defined above in a space in which the conventional LCD display is placed. Even if affixed to a wall or ceiling, the conventional LCD display is unable to provide general illumination as defined above. However, in somewhat more detail, modifications to enhance the efficacy of a display device will now be described with reference to examples of several technologies suitable for improving the efficacy of the conventional display. In that regard, we will first consider some examples of display components that may be enhanced for use in implementations of lighting devices like those described above, for example, with respect to FIGS. 1 to 5B.

For example with reference to FIGS. 7A and 7B, a lighting device, such as lighting device 11 of FIG. 4 may incorporate as the controllable image generation and lighting system 111, an enhanced display device 600. For example, the enhanced display device 600 includes an enhanced light source 610, which corresponds to the light source 110 of FIG. 4. Similar to light source 110, the enhanced light source 610 may be any type of light source, such as one or more light emitting diodes (LED), a fluorescent lamp, compact fluorescent lamps (CFL), plasma, a halogen lamp(s) or the like, but is a light source that generates light greater than 4000 lumens (which is greater than the 2000-4000 lumens of the conventional display).

Alternatively, the enhanced light source 610 may include an increased number of light sources greater than the number of light sources in a conventional backlight unit. The additional light sources increase the brightness of the light output by the enhanced light source 610 when the display 600 is used in an illumination mode. As an example, if the conventional display 500 had 10 CFL tubes as the backlight, the backlight light source 610 of the enhanced display 600 may be increased to 100 CFL tubes. The increased number of light sources provides increased light output by a factor of 10, and hence the LC display 600 is useful for illuminating a space. In another example, if the display was ‘directly’ backlit, meaning the light sources such as LEDs were assembled on the backlight in a matrix format, the number of LED sources may be increased manifold to increase the output in the illumination mode (as opposed to the display mode). By adapting the enhanced display 600 to include the enhanced light source 610, the enhanced display device 600 produces general illumination satisfying governmental and/or industry (e.g., IES, ANSI or the like) standards for a general lighting application of a luminaire. General illumination is the output of light or presence of light in a location acceptable for a general application of lighting according to one or more of the above mentioned standards. A general application of lighting may be a task lighting for an office space or a work area. In addition or alternatively, the performance of the enhanced display 600 satisfies or exceeds currently existing performance standards, such Leadership in Energy & Environmental Design (LEED) interior lighting-quality standard, other governmental standards, other industry standards, or the like. Similar enhancements could be made if the sources were mounted on the edge of the display (edgelit displays).

The enhanced light source 610 may include one or more light emitters and a coupling structure, such as a light box or light guide, that are arranged to supply generated light toward an output surface of the lighting device 11. In addition, the modified light source 610 may be controllable to provide a variable light intensity output. For example, the modified light source 610 may have a light output value in ranges of or a combination of ranges, such as approximately 100-2,000; 2,000-4,000; 4000-10,000; or 10,000-20,000 lumens per watt in the illumination mode, the display mode, or both. In some examples, the light source 610 may have a light output value that is greater in the illumination setting than when in the display setting.

In a first example, a step toward providing a lighting device that utilizes display technology is to provide an enhanced light source 610 such that the enhanced display generates light of sufficient intensity to overcome the attenuating effects of the multiple layers of filtering and color conditioning of a typical display to thereby provide general illumination lighting expected from a luminaire.

The enhanced light source 610 generates light suitable for illuminating a space for a general lighting application, but additional modifications not only provide additional increases in the output light brightness, but also provide a closer approximation of the light distribution expected from a lighting device/luminaire. For example, by changing certain films in the stack of an LCD display to provide controllable, or switchable, components, such as a switchable diffuser and/or a switchable polarizer, the total brightness of the lighting device output can be further improved and hence also increases the lighting efficiency of the lighting device.

As illustrated in the example of FIG. 7A, the enhanced display 600 in addition to the enhanced light source 610 also includes one or more switchable diffusers 620/660, a switchable polarizer 630, optionally one or more quarter wave plates 641, 642, and a liquid crystal filter array 650. The light source 610 and the components 620, 630, 650 and 660 in the LCD stack may be responsive to control signals from a controller, such as processor 123 or driver system 113 of FIG. 4. Under control of the controller (not shown in this example), one or more of the components 620, 630, 650 and 660 may be configured to have different light processing characteristics depending by the mode indicated by control signals from the controller. For example, one mode (i.e., state) of the one or more switchable diffusers may be an illumination mode (i.e., a more transparent state) and another mode may be a display mode (i.e., a more diffuse state). In the illumination mode, one or more of components 620, 630, 650 and 660 is configured to process light generated by the light source 610 to provide general illumination for the space in which the lighting device is installed. Conversely, in a display mode, one or more of components 620, 630, 650 and 660 is configured to process light generated by the light source 610 to present an image. In an example, the different modes and the related component settings are illustrated in FIGS. 7A and 7B.

FIG. 7A illustrates the example of an enhanced display 600 in a display mode. A controller, such as processor 123 of FIG. 4, coupled to the enhanced display 600 may indicate that the enhanced display 600 is in a display mode. In display mode, the controller controls the light source 610 to generate light suitable for producing an image. The light generated by the light source 610 when in display mode may have a reduced intensity light as compared to the intensity of light generated by the light source 610 when in illumination mode.

In the display mode of FIG. 7A, control signals are provided to the switchable diffuser 620 to configure the switchable diffuser 620 for display mode. In the example, the display mode configuration of the switchable diffuser 620 is to apply a control signal that turns the diffuser 620 to an OFF or diffuse state, which is a state in which the diffuser 620 diffuses the light output from the enhanced light source 610. A switchable diffuser, such as 620, may be implemented utilizing privacy glass, smart windows, or the like.

Similar to the diffuser 620, the switchable polarizer 630 is also switchable between an illumination mode and a display mode. However, the light processing function of the polarizer 630 is different than the light processing function of the diffuser 620. When in the display mode, the polarizer 630 is in an ON or polarizing state. The switchable polarizer 660 is also switchable between the display mode and the illumination mode. When in the display mode, the polarizer 660 is in an ON or polarizing state. A switchable polarizer 630, 660 may also be implemented utilizing Polymer Stabilized Cholesteric Texture Liquid Crystal (PSCT-LC) materials which can selectively reflect one type of polarized light but transmit light of another polarization type, and can also be switched to a completely transparent state. Also switchable Polarization Gratings (PGs) may also be used as the switchable polarizer 630, 660.

The liquid crystal filter 650 is electrically controllable and passes light generated by the light source 610, the switchable diffuser 620 and switchable polarizer 630. In the present example, the transparent LCD array 650 does not have polarizers, but is responsive to control signals applied to two electrodes: a TFT-Side ITO electrode 651 and a color filter side ITO Electrode 653. In the example, the liquid crystal filter array 650 is controllable to emit light of different colors based on control signals received from the controller, and as such, in the display mode, provides the color filtering for providing image data that is displayed as an image output.

The functions of each of the diffuser 620 and the switchable polarizers 630 and 660, when in the display mode, is the same as in the conventional display 500. Similarly, the optional quarter wave plates 641 and 642 are similar to optional quarter wave plates 541/542, and also function as described above with respect to the conventional display 500. For example, the one or more quarter-wave plates 641 and 642 are configured to pass light having a predetermined polarization.

FIG. 7B illustrates an example of an enhanced display 600 in an illumination mode. For example, a controller, such as processor 123 of FIG. 4, is coupled to the enhanced display 600, and provides control signals that configure the enhanced display 600 for the illumination mode. In the illumination mode, the controller controls the light source 610 to generate light suitable for generating light having an intensity suitable for general illumination of the space in which the lighting device is installed. The light generated by the light source 610 when in illumination mode may be of greater intensity than the light generated by the light source 610 when in display mode. Additionally, when in illumination mode, the components 620, 630, 650 and 660 are also controlled to increase the light output efficiency of the enhanced display 600.

The controller also controls the switchable diffuser 620 and switchable polarizers 630 and 660 according to the illumination mode settings. For example, the control signals received from the controller may configure the switchable diffuser to an ON state or clear state. In the illumination mode, the switchable diffuser 620, switchable polarizer 630 and 660 are substantially transparent and pass a greater percentage of the light generated by the light source 610 than when in the display mode. Similarly, the LC filter 650 and switchable polarizers 630, 660 receive control signals that may add color characteristics (e.g., color, color temperature, and/or the like) to the light generated by the light source 610. For example, if the light source 610 generates substantially white light, the LC filter 650 and switchable polarizers 630, 660 may adjust color settings to provide a color temperature indicated by the configuration data provided to the controller.

As a result, when in the illumination mode, the enhanced display 600 is substantially more efficient for use as a general illumination light source, and, in some instances, the brightness of the output light is at least 4 times greater as compared to the output brightness of the light when the enhanced display device 600 is in the display mode.

In order to implement the switching of the diffusers and polarizers as explained with reference to FIGS. 7A and 7B. The switchable diffuser 620 may be constructed with polymer dispersed liquid crystals (PDLCs), polymer stabilized cholesteric texture liquid crystals (PSCT-LCs), or the like. An example of a PDLC is illustrated in FIG. 8 and will be described briefly. To provide the PDLC, a substrate 700 is formed with a suspending liquid, such as polymer matrix 720, having suspended therein voltage sensitive spheres, such as a liquid crystal (LC) domain spheres 710. As illustrated in FIG. 8, a PDLC 700 also includes ITO electrodes 740, and a switch/voltage source 930. A controller (not shown) provides control signals and/or applies voltages to control the states of the PDLC 700. The LC domain spheres 710 contain liquid crystals in a first orientation as shown in (a) of FIG. 8. In the first orientation shown in (a) of FIG. 8, the LC domain spheres 710 are randomly oriented within the suspending liquid, polymer matrix 720 to scatter light in a number of different directions making the output surface of the substrate 700 appear diffuse (or in the OFF state) to a viewer. The OFF state labeled (a) in FIG. 8 corresponds to the display mode described above with reference to FIG. 7B. In the OFF state shown in (a) of FIG. 8, a control voltage is not applied between the electrodes 740 and 741. In the case of a control voltage not being applied, the LC domain elements 710 are randomly arranged within the polymer matrix 720, and the visible light generated by the light source and input to the diffuser is diffusely scattered. Conversely, upon application of a control voltage via switch/control voltage 730 as shown in (b) of FIG. 8, the LC domain elements 710 become aligned within the polymer matrix 720 such that the PDLC is transparent, and the visible light generated by the light source passes substantially unimpeded through the polymer matrix 720.

Returning to the examples of FIGS. 7A and 7B, the functions and operation of the PSCT-LCs that may be used in either the diffuser 620 or the polarizers 630, 660 are substantially similar to the PDLC as described with reference to FIG. 8. However unlike PDLC, PSCT-LCs are not randomly oriented within the spheres and therefore they can polarize the reflected and transmitted light accordingly when no voltage is applied. When a voltage is applied, they are similar to the PDLCs and transmit substantially all of the input light.

The above described enhanced display examples illustrated in FIGS. 7A and 7B enable a processor to switch a lighting device between providing general illumination associated with a basic luminaire and an image display. Using the enhanced display device 600, the software configurable lighting device provides general illumination with the enhanced display device 600 in the illumination mode, by providing light that is brighter as compared to when the enhanced display device 600 is presenting an image in the display mode.

The switching between the display mode of FIG. 7A and the illumination mode of FIG. 7B may be accomplished according to a time division multiplexing scheme. In such a time division multiplexing scheme, a driver system, such as driver system 113 of FIG. 4 may be configured to, either by accessing a memory or in response to control signals from a processor, such as processor 123, or external processor, execute a time division multiplexing scheme for controlling switching between a display mode and an illumination mode. In an example, the driver system, when signaling a switch to display mode, generates control signals for presenting the image on the display device based on the received image data during a first periodic interval of the time division multiplexing scheme. Conversely, when signaling a switch to illumination mode, the driver system generates control signals for the display device to generate illumination lighting to compliment the light output from the general illumination device during a second periodic interval of the time division multiplexing scheme different from the first periodic interval.

FIG. 16 is a timing diagram useful in understanding a time division multiplexing approach to the display and lighting functions. The driver, controller or a processor, such as those described with reference to FIG. 4, may receive timing signals for controlling the respective display and lighting functions based on a timing diagram like the simplified illustration of FIG. 16.

In this example, the timing diagram shows a time cycle tc that includes time durations related to the general illumination lighting time duration tl and the display presentation time period td. The example timing diagram may indicate timing for a specific general lighting duration and/or a particular type of image display, and is only an example. Other timing signals may be suitable depending upon different user selections and lighting conditions selected for a space or the like. The time cycle tc may be an arbitrary time duration. The time cycle tc is likely to be a duration that does not allow the transition from general illumination lighting during time period tl to presentation of the image display during period td to be discernible (e.g., as flicker, changes in contrast of objects in the room, or the like) by a person in the space. In addition, although the time durations tc, tl and td are shown as periodic, each of the respective time durations tc, tl and td may be aperiodic to enable different general illumination distributions and image displays.

Returning to the examples of FIGS. 7C and 7D, enhancements are not limited to simply enhancing components, such as a diffuser or a polarizer, on an individual basis. In contrast to the example of FIGS. 7A and 7B, the example illustrated in FIGS. 7C and 7D replaces both the diffuser and polarizer with an optical film that appears translucent at some angles, but transparent at other angles. An example of such an optical film is Lumisty™ provided by Glassfilm Enterprises, Inc. Optical films, such as Lumisty™, have fixed optical properties that process light differently depending upon the angle at which the light output from the optical film is viewed. These fixed optical properties may be leveraged so that the lighting device, such as lighting device 11, is able to deliver an image display and general illumination as a luminaire at the same time or enables the image display to be viewed at some angles and the general illumination luminaire from other angles.

In the examples of FIGS. 7C and 7D, the conventional display 500 is replaced with the enhanced display 601. The enhanced display 601 for inclusion in the lighting device 11 includes a light source 615, an optical film 625 and a transparent LC color filter with polarizers 655. The light source 615 The transparent LC color filter includes a TFT-side ITO electrode 656 and a color filter side ITO electrode 658. The light source 615 of the enhanced display 601 is the same as or substantially similar to the light source 610 of the enhanced display 600 of FIGS. 6A and 6B. In the example of FIGS. 6C and 6D, the light source 615 may provide, in some implementations, a lumen output of 2000-8000 lumens. In other implementations, the lumen output of the light source 615 may be 5-10 times greater than the lumen output from the backlight in the conventional LCD display 500. In contrast to the transparent LCD 650 of FIGS. 7A and 7B, the transparent LCD 655 of FIGS. 7C and 7D includes polarizers, which act to polarize and filter the light generated by the light source 615.

In the example of FIGS. 7C and 7D, the transparent LCD 655 is controllable to permit presentation of an image display as well as throughput of light suitable for general illumination. For example, some pattern of color filtering control may be implemented that enables groupings of pixels to be used only for image presentation, such as every other pixel is related to displaying an image, or groups either separately present imagery or provide general illumination (e.g., 5-50 pixels for image display and 5-50 pixels for general illumination). With the presentation of light suitable for general illumination, the light processing effects of the optical film 625 are effective for allowing some viewers to view the image presented by the display device 601 of the lighting device 11 and to provide general illumination to the space in which the lighting device 11 is installed. In other words, the described enhanced display 601 for use in a lighting device as shown in the example of FIGS. 7C and 7D enables the lighting device to simultaneous provide general illumination and image display from different directions and angles.

For example with reference to FIG. 7C, at angles of, for example, approximately −25 to approximately 25 to normal (normal being perpendicular to the optical film 625 output surface), the optical film 625 may be transparent and light generated by the light source 615 passes through the optical film 625 and the color filtering, transparent LC 655 for presentation of an image or providing a substantial portion of the general illumination to the space. While at angles of 25 to 55 from normal, as shown in the example of FIG. 7D, the optical film may be diffuse, thereby reducing the directional intensity of the light and also improving the contrast-ratio of the image display to allow viewers to see images at these angles.

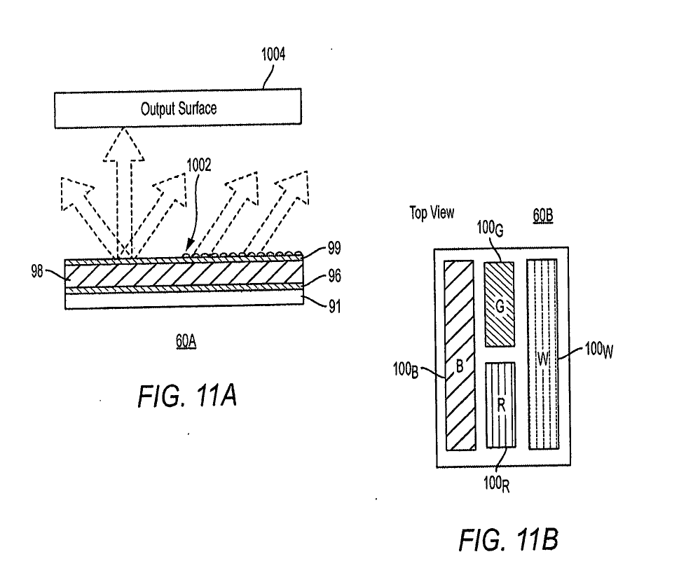

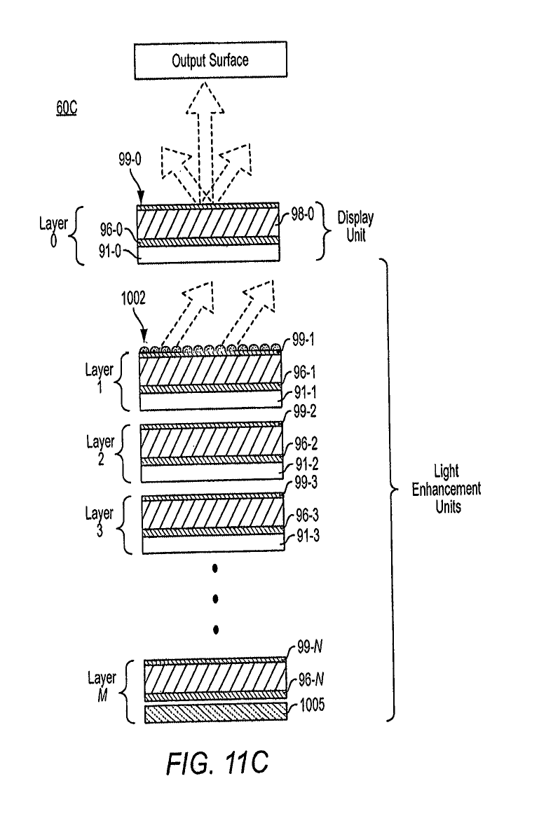

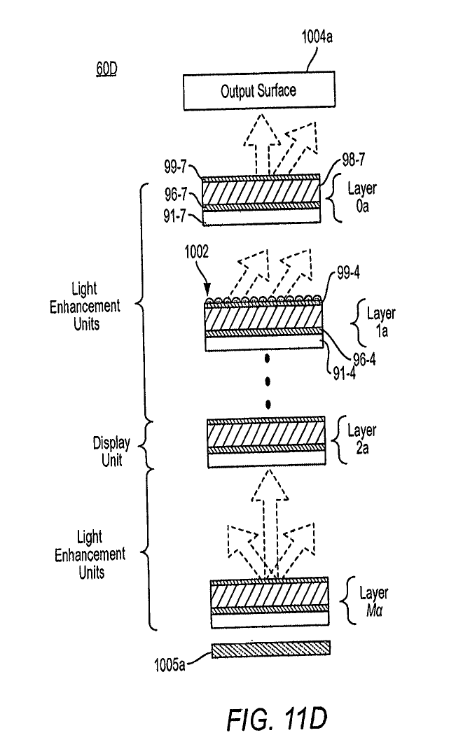

In another example, an apparatus is envisioned that has multiple light processing layers removed, such as the transparent LC color filter with polarizers 655 and the respective electrodes 656 and 658 of a display device, leaving only light source 615. The light source 615 may be a commercial-off-the-shelf backlight unit, such as those provided by backlight unit manufacturers PHLOX, Metaphase Technologies, Inc., Lumix or the like. The transparent LC color filter with polarizers 655 and the respective electrodes 656 and 658 are replaced with an optical device, such as a film or microlens having a predefined light output distribution. Such an apparatus includes a light source configured to produce an illumination light output having industry acceptable performance for a general lighting application of a luminaire, and an optical device that is coupled to the light source. The optical device, such as optical film 625, is configured to distribute the illumination output light in a predefined light output distribution from the apparatus. The light source 615 of the light source may be a OLED device (i.e., 91, 96, 98 and 99) as in 60A of FIG. 11A, a non-organic LED, a CFL, a fluorescent tube, a halogen lamp, or other suitable light source coupled adjacent to, such as to the side or behind, the optical device that provides the light output having the industry acceptable performance.

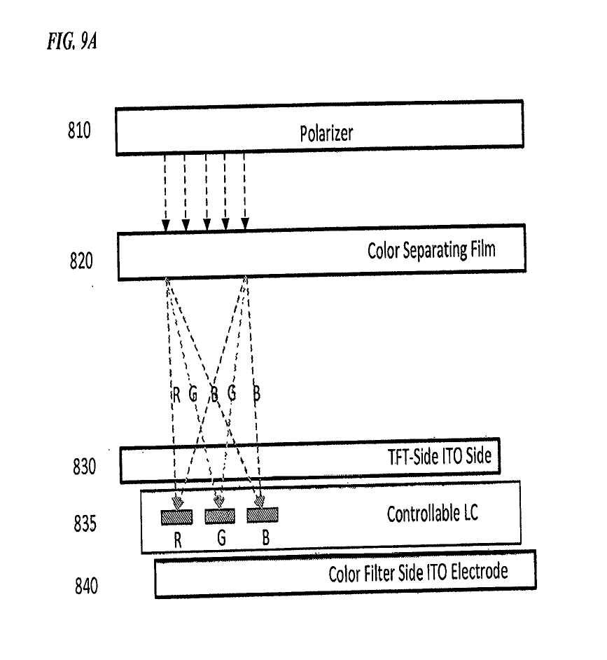

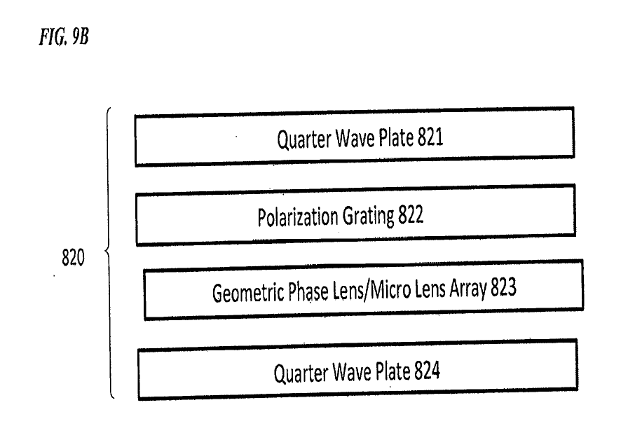

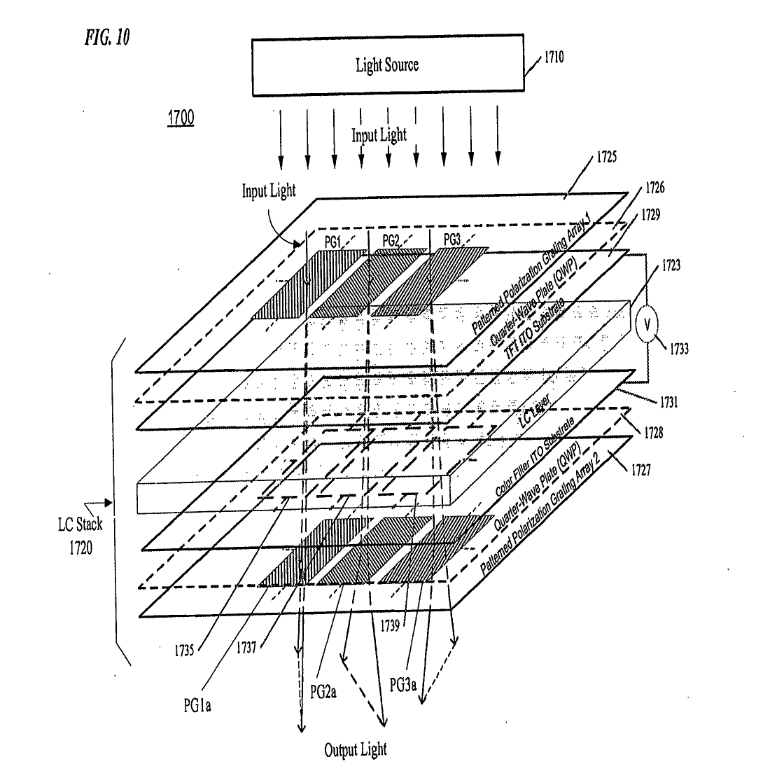

Other examples of enhanced displays that include improved components of a conventional LCD display as shown in FIG. 6 are also contemplated. For example, FIG. 9A illustrates an example of color separating film, FIG. 9B illustrates another example of a color filtering improvement to a LC display, and FIG. 10 illustrates an example of a patterned polarization grating improvement to an LC display.

In the conventional approach as shown in FIG. 6, the white back light (which is comprised of R, G and B components) is passed to the LC 552 for color filtering at the pixel level, which means that at a particular pixel only one of the color components, for example, R, is passed and the light of the other two components (in this example, G and B) is lost or wasted. This occurs at each pixel location of the LC 552. In other words, only one-third of the provided light passes and the other two-thirds of the provided light is blocked or otherwise, wasted.

One method of increasing the efficiency of the display is passively color filter the provided light prior to the light being delivered to the LC. In FIG. 9A, a portion of an LCD is illustrated in which LCD component layers 810-840 are disposed between a light source (not shown) and a second polarizer (also not shown). A first polarizer 810 receives light from the light source. The light source (not shown) may be a light source as described herein. The polarizer 810 receives the input light and polarizes the light according to predetermined settings. The light output from the polarizer 810 is provided to a pixelated, or channelized, color separating film 820. The color separating film 820 separates, at a pixel level, the input light received from the polarizer 810 into respective colors (e.g., RGB) and passes the color component light to the controllable LC color filter 835. The color separating film 820 may be fabricated in the form of pixels that separate the incident light into the respective different color components (e.g., RGB). As shown in FIG. 9A, the separated different color component light beams output from the color separating film 820 pixels are steered toward a corresponding color component filter of the controllable LC color filter 835. Although only one instance of the color separation is shown, a large number of color separations occur. Since there are a large number of pixels and color filters in both the color separating film 820 and the controllable LC color filter 835. The alignment of the color separating film 820 with the controllable LC color filter 835 filter pattern is such that the light separated by the color separating film must be substantially aligned the controllable LC color filter 835 to realize the full potential of the light savings. However, the addition of the channelized color separating film 820 may be worthwhile even if the alignment is less than precise since the resulting color separation may realize additional efficiency.

The channelized color separating film 820 may be realized through a number of implementations. FIG. 9B illustrates an example configuration of a channelized color separating file usable in the example of FIG. 9A. The channelized color separating film 820 may include a number of layered light manipulating components arranges as layers in a stack. A first layer in the color separating film 820 stack may be a first quarter wave plate 821, followed, in order, by a polarization grating 822 a geometric phase lens/microlens array 823, and a second quarter wave plate 824. The film 820 is configured to take incoming light, separate the light into the color components at locations that match the LC 835 color filter pattern. The quarter wave plate 821 converts the incoming linearly polarized light to circularly polarized light to pass to the polarization grating 822 which separates the incoming light into the respective color components. The separated light is focused by a geometric phase lens and/or a microlens array 823 toward the LC color filter 835. The second quarter wave plate 824 reconverts the circularly polarized light to linearly polarized light so the LC color filter 835 may receive the light output from the quarter wave plate 824.

FIG. 10 is an exploded isometric view of a liquid crystal (LC) panel configured as an enhanced display device 1700 as may be used in any of the software configurable lighting device examples. The view in this figure illustrates a method to convert a conventional LC stack into a beam shaping device. The polarizers, such as 531, 532 of FIG. 5, are removed from either side of the conventional LC panel, and, in the enhanced display device 1700, are replaced with patterned polarization grating (PG) arrays 1725 and 1727. The PG arrays 1725, 1727 have individual polarization gratings with different grating periods and orientations aligned to respective sub-pixels. The number of sub-pixel polarization gratings in each of the PG arrays 1725, 1727 logically associated with one pixel of the spatial modulator may be two, three or higher. In the example, there are three polarization gratings in each of the PG arrays 1725, 1727 logically associated with one pixel of the spatial modulator. Hence, in the illustrated example, the first patterned PG array 1725 includes three individual polarization gratings PG1, PG2 and PG3; and the second patterned PG array 1727 includes three individual polarization gratings PG1a, PG2a and PG3a. The LC stack 1720 includes transparent ITO electrode layers 1729, 1731 as shown in the figure. In addition, there are Quarter-Wave Plates (QWPs) 1726, 1728 between the PG arrays 1725, 1727 and the respective electrode layers 1729, 1731. The QWPs 1726, 1728 convert the circularly polarized light from PGs to linearly polarized light required for some LC based devices. In some LC based devices, this may not be required as they may be able to operate with circularly polarized light.

A voltage can be applied by a source driver 1733 to cause the LC molecules to change their alignment. The ITO layer 1731 includes electrodes for the pixel, and the other TTO electrode layer on the substrate 1729 has Thin Film Transistors (TFTs) within each of the sub-pixels 1735 to 1739, for switching the voltage of each of the LC sub-pixels 1735 to 1739. By controlling the voltages, the amount of polarization rotation caused by each sub-pixel in the LC layer 1723 can be controlled from 90 degrees (No voltage) to almost 0 degrees (High Voltage ˜10-20 V).

The first PG array 1725 creates polarized diffracted orders that pass through the LC layer 1723. Just like in a conventional LCD, the sub-pixel 1735 to 1739 in the LC layer 1723 can selectively adjust the polarization states of these orders depending on the respective sub-pixel voltages from a source 1733, although the polarization of from each respective one of the gratings PG1 to PG3 for the pixel is different the light polarization supplied by the other gratings for that pixel. The second PG array 1727 receives the diffracted orders from the sub-pixel 1735 to 1739 and selectively redirects them to higher or smaller angles depending on the polarization state. Therefore a multitude of beam shapes may be created simply by configuring the voltage patterns applied to the various LC sub-pixels 1735 to 1739. The color filter 1731 can be used to compensate for any chromatic dispersion caused by the polarization gratings, and also adjust the color temperature of the projected light. Compared to a conventional LCD, there is a brightness enhancement of a factor of 6 in this spatial modulator implementation when no color filters are used, and a factor of 2 when color filters are used, since no light is blocked by the PG arrays ideally.

Although the stack 1720 is derived from an LCD display device, the device 1700 in the example may be configured to implement an enhanced display lighting device, with selective distribution control for luminaire emulation. For example, the source 1710 may be an enhanced light source, for example, including a greater number of individual light sources than the conventional LCD light source 510 of FIG. 6 (or have a light source with a greater lumen output than a conventional LCD light source, such as 510), and the LC stack 1720 can be configured/controlled to provide a selected general illumination output distribution meeting governmental building codes and/or industry standards as well as providing a perceptible image representation.

As shown by the above discussion, functions relating to communications with the software configurable lighting equipment, e.g. to select and load configuration information into such equipment, may be implemented on computers connected for data communication via the components of a packet data network, operating as the on-premises network 17 and/or as an external wide area network 23 as shown in FIG. 5A. Although special purpose devices may be used, such devices also may be implemented using one or more hardware platforms intended to represent a general class of data processing device commonly used to run “server” programming so as to implement the virtual luminaire store functions at 28 and configured to operate as user terminal devices shown by way of example at 25 and 27, albeit with an appropriate network connection for data communication.

The controllable image and light generation system 111 in the lighting device 11 of FIG. 4 includes a light source 110. Such a light source may be fabricated so that the lighting device is controllable to provide both an image display and general illumination. A technology suitable for use with such a light source is organic light emitting diodes, or OLEDs. As shown in FIG. 11A, a light source configured from an OLED semiconductor stack 60A may include from top to bottom, an optional beam shaping/beam steering layer 1002, a cathode 99, an organic layer (including transport layer and emissive layer) 98, an anode 96, and a substrate 91. An output surface 1004 of the lighting device 11 is also illustrated. The output surface 1004 may be a thin transparent material such as glass that protects the OLED layers from physical damage and/or dust or the like. In addition, as described later the output surface 1004 is a point of reference as the stack of OLED layers, such as 91, 96, 98 and 99, are formed with their vertical axes perpendicular to the output surface 1004.

OLEDs as a light source provide an additional benefit of increased transmissivity of the generated light because most materials used in an OLED display/illumination unit implementation are transparent. Different OLED technologies may be used such as active-matrix organic light-emitting diode (AMOLED), passive-matrix organic light-emitting diode (PMOLED), Organic Light-Emitting Field-Effect Transistor (OLET), or the like to provide a substantially transparent display/illumination unit based on organic semiconductor: For example, in an AMOLED light source, a substrate, electrode and organic layer are transparent. By implementing transparent oxide material as a transistor and reducing the area of transistor, the transmissivity of AMOLED can be largely increased. Meanwhile, OLETs fundamentally eliminate the usage of non-transparent semiconductor materials, such as transistors, which is beneficial since, the light source 110 is essentially a transistor. Similarly, PMOLEDs provide the advantage that substantially all transistors used in the light source 110 are transparent is used and the unit is controlled by transparent electrode.

The OLED stack 60A also lends itself to other implementations. For example, an apparatus is envisioned that includes a light source unit configured to produce an illumination light output having industry acceptable performance for a general lighting application of a luminaire. The apparatus also includes an optical device, such as a film or microlens, that is coupled to the light source. The optical device, such as 1002, is configured to distribute the illumination light output in a predefined light output distribution from the apparatus. The light source may be a OLED device (i.e., 91, 96, 98 and 99) as in 60A of FIG. 11A, a non-organic LED, CFL, a fluorescent tube, a halogen lamp or other suitable light source coupled adjacent to, such as to the side or behind, the optical device that provides the light output having the industry acceptable performance.

FIG. 11B illustrates an example of an OLED structure that may be usable in an example of a software configurable lighting apparatus of FIG. 4. The example OLED of light source 60A may include a light output surface 1004 and a display formed from the OLED layers to provide a controllable color pixel unit. FIG. 11B illustrates a functional diagram of stackable OLEDs usable in an example of a software configurable lighting apparatus of FIG. 4. A pixel unit may be realized using any or a PMOLED, AMOLED or OLET as elements of a pixel unit 60B. On advantage of using OLEDs is that the materials used to fabricate the OLED are transparent, such as a glass substrate, indium-tin-oxide (ITO) transparent electrodes, an organic emissive layer, an organic transport layer, and an encapsulation layer. In addition, the transmissivity may be further increased by the following approaches: (i) use more advanced fabrication technology to shrink the gate electrode length thereby reducing the non-transparent transistor area, and (ii) utilizing transparent transistors, such as an oxide transistor, in particular, an indium gallium zinc oxide (IGZO) transistor or the like.

In the example of FIG. 11B, four different organic emissive units 100R, 100G, 100B and 100W, respectively, emit red, green, blue, and white light, which is suitable for both a display function and an illumination function. The white emissive unit 100W is optional for enhancing the illumination intensity. Alternatively, one organic emissive layer emitting white light may be combined with red, green, and/or blue color filters. The use of color filters may be considered a trade-off between color rendering for illumination purposes and the color gamut for display purposes. An advantage of using an RGBW OLED instead of using a white LED with RGB color filter, is that the RGBW OLED provides higher efficiency and better color rendering capability because of its wide spectral power distribution.

Since OLEDs are emissive (meaning the device emits light) and are transparent, a number of OLEDs may be stacked one on top of the other so that the light generated by stacked OLEDs is combined to provide light having an increased lumen output, or perceived brightness. FIGS. 11C and 11D illustrate functional diagrams of an example of stackable OLEDs usable in the example of a software configurable lighting apparatus of FIG. 4. The examples of FIGS. 11C and 11D provide different examples of display and illumination layers formed using OLEDs. For example, the display/illumination unit 60C of FIG. 11C includes OLED layers 1-M and backing substrate 1005. The backing substrate 1005 may be reflective, non-transparent, or a combination of both reflective and non-transparent. For example, a reflective backing substrate 1005 provides the benefit of reflecting the light backward from any upper-level transparent OLED lighting layers, which reduces optical losses and increases luminance output. At least one of the transparent and emissive layers 0-M is a display layer for presenting an image display toward the light output surface 1004 of the lighting device. For example, of the OLED layers 1-M in FIG. 11C, at least one or more transparent and emissive layers 1-M is an illumination layer for generating light for general illumination of a premises, and at least another one or more of the remaining M-1 transparent and emissive layers is a display layer for displaying an image. In the example of FIG. 11C, the display layer may be layer 0 adjacent to the output surface 1004. The display layer (layer 0) includes transparent (e.g., ITO) electrodes 99-0 and 96-0, and transparent substrate 91-0, and the remaining layers 1-M may be illumination layers that generate light for general illumination. The beam shaping/beam steering film 1002 may provide a predetermined beam shaping/beam steering effect. In the example, the beam steering film 1002 diverts the output image display and general illumination light at some angle from normal (i.e., normal being perpendicular to the output surface 1004. Alternatively, the display layer is a first layer, layer 0, adjacent to the output surface 1004.

In the example, the one or more illumination layers 1-M are configured as a stack of layers in which the vertical axis of the stack is perpendicular to the light output surface 1004. A controller (not shown), such as microprocessor 123 of FIG. 4, is coupled to electrodes 99-1, 99-2, 99-3 . . . 99-N of the OLEDs in the respective layers 1, 2, 3, . . . M including the display layer and the one or more illumination layers. M and N may be some integer values selected to provide selected or predetermined display and/or general illumination performance. The controller is configured, for example, by executing programming stored in a memory, such as memory 125, to control operation of the display layer and the one or more illumination layers. Alternatively, the display layer is formed from a number of OLED layers, such as not only layer 0, but also layer 3, or any other layer(s) in the stack of OLED layers 0-M. The determination of which layers 0-M are display layers may change depending upon the configuration data provided to the lighting device.

The display/illumination unit 60D of FIG. 11D illustrates another example of an OLED stack configuration. The display/illumination unit 60D includes an output surface 1004a, the surface of which is perpendicular to the vertical axis of the OLEDs in the respective layers 0a-Ma, and backing substrate 1005a. The backing substrate 1005a may be reflective, non-transparent, or a combination of both reflective and non-transparent. The individual OLEDs of the respective layers in the display/illumination unit 60C of FIG. 11C are constructed in the same manner as the OLEDs of the respective layers in the display/illumination unit 60D of FIG. 11D, but may be arranged in the stack of OLEDs of layers 0a-Ma. For example, layer 1a of 1 display/illumination unit 60D includes an OLED formed with a beam shaping/beam steering film 1002, while the OLED in layer 0 of the display/illumination unit 60C of FIG. 11C is formed with the beam shaping/beam steering film 1002. At least one OLED layer in the layers 0-Ma in the example of FIG. 11D is a display unit OLED. As shown in FIG. 11D, layer 2a is the display unit that is controlled via control signals from a controller to generate image light. The different configurations of OLEDs may be arranged in any of the layers 0-Ma so selected or predetermined display and/or general illumination performance is provided. The placement of the display layer in the OLED stack may be interchangeable with another OLED layer by outputting display signals to the different layer. The number of illumination layers, which are, individually or in combination, illumination devices, depends on illumination-related configuration data in the configuration file. Although not illustrated as such in FIGS. 11A-11D, one illumination layer may consist of multiple-stacks of organic emissive element layers. Furthermore, the bottom two layers of a stack may be either transparent OLED layers with a reflective layer or a non-transparent OLED layer.

Other implementations are also envisioned. For example, the beam shaping/beam steering film 1002 of FIGS. 11C and 11D may be replaced with a controllable device that provides different directional effects to light output by the OLED. FIG. 11E illustrates examples of various states of an OLED usable in the examples of FIGS. 11A-11D. In particular, the beam steering/shaping device 1003 with display/illumination unit 60E underneath. As shown in (a) of FIG. 11E, the output format of optical beam can be electrically controlled by beam shaping/steering device 1003 in response to a voltage applied by voltage source 1015. In the example of FIG. 11E, four states are illustrated. In example (b), an OFF state is shown. In the OFF state, the voltage source 1015, for example, may not apply any voltage to the beam shaping/steering device 1003, and as a result, the optical output from the display/illumination unit 60E is dispersive. Upon application of a particular voltage from voltage source 1015, the beam shaping/steering device 1003 changes states, for example to state A. In example (c), the state A represents an ON state in which the steers the output light beam with a positive angle with respect to the normal direction. Conversely, in example (e), in state C: the direction of the light beam output from beam shaping/steering device 1003 has a negative angle with respect to the normal direction. Beam shaping/steering device 1003 may have another state, state B, which as shown in example (d) configures the beam shaping/steering device 1003 to output light in the direction of is normal to the output surface 1004. A number of the display/illumination units 60A-60D may be arranged adjacent to one another in an array to provide an enhanced display, usable with controllable system 111 of FIG. 4.

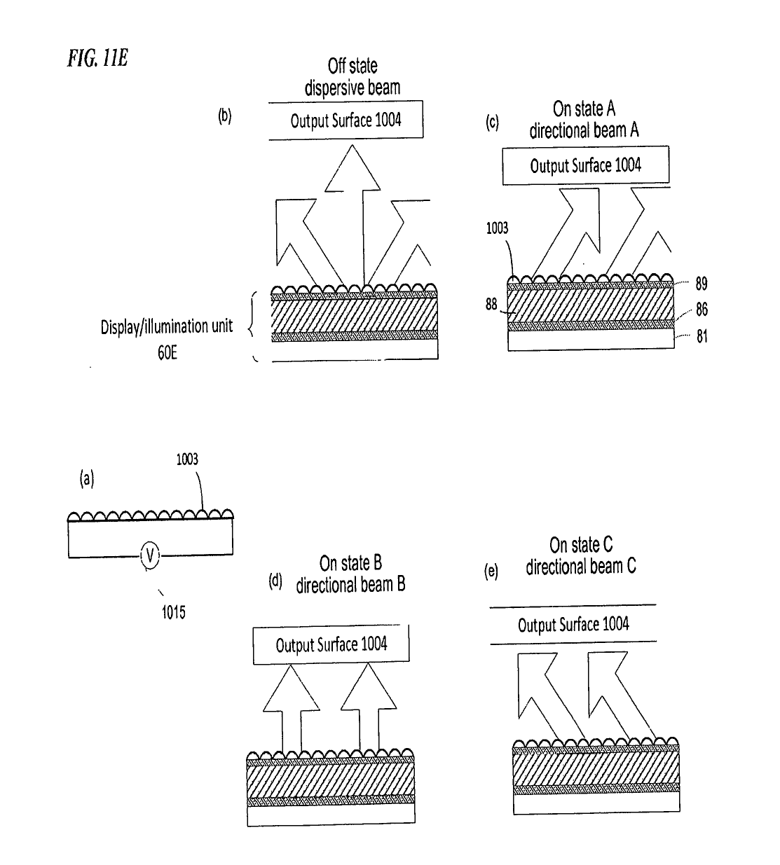

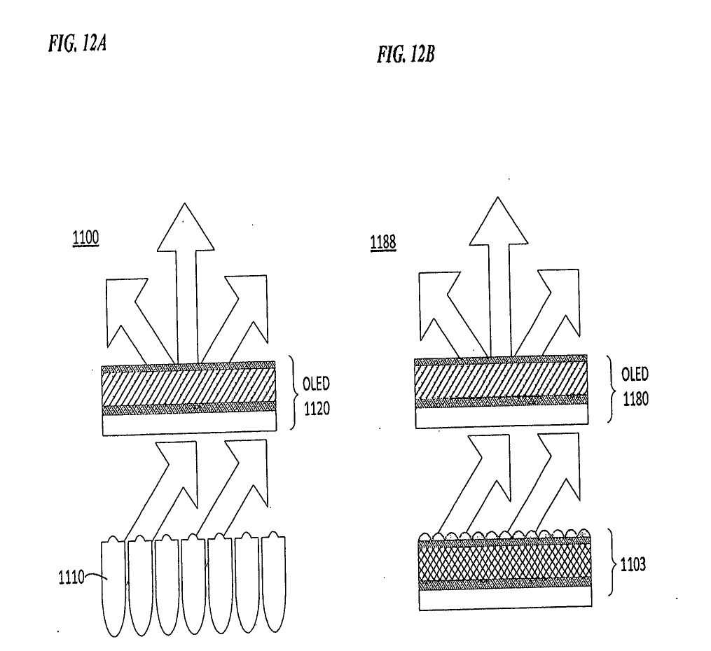

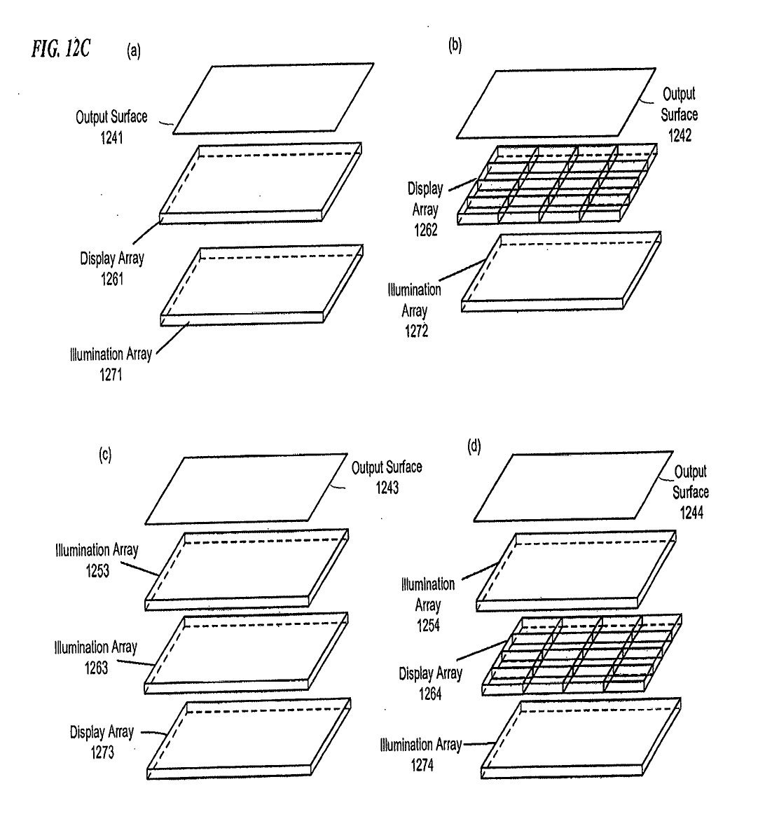

Since the display/illumination units 60A, 60B, 60C and 60D are transparent, other configurations that take advantage of this transparency are also envisioned. FIGS. 12A and 12B illustrate examples of non-organic back lighting of a transparent OLED and the response of OLED to the non-organic back light for use in a stack of OLEDs, such as those shown in FIGS. 11C and-11D.

FIG. 12A illustrates examples of configurations of display/illumination units, such as 1100, usable with additional back lighting sources. The display/illumination unit 1100 may include one or more OLEDs 1120 as well as additional light sources, such as 1110. The additional lighting sources 1110 may, be for example, a fluorescent lamp(s), a halogen lamp(s), a metal halide lamp(s), a high/low pressure sodium lamp(s), or the like.

FIG. 12B is another example a transparent display/illumination units, such as 1188 with additional back lighting sources that are semiconductor-type light emitting light sources. In the example of FIG. 12B, the display/illumination unit 1188 may include one or more OLEDs 1180 as well as semiconductor light-emitting devices, such as a light-emitting diode(s), a superluminescent diode(s), a laser diode(s) or the like.

Although only one OLED, 1120 or 1180, is shown in each of the examples of FIGS. 12A and 12B, of course, additional OLEDs, such as the layers of OLEDS shown in FIGS. 11A and 11B, may be used in combination with the additional backlighting sources 1110 or 1103. For example, the additional backlighting sources 1110 or 1103 may be disposed on top of backing substrate 1005 or 1005a. For example, backlighting sources 1110 may be conventional light sources, such as fluorescent lamps or other similar gas-discharged lamps. Meanwhile, backlighting sources 1103 may be inorganic semiconductor light sources such as light-emitting diodes, superluminescent diodes, laser diodes or the like.

FIG. 12C illustrates several examples of a display array and illumination array configurations in an enhanced display panel usable in a software configurable lighting apparatus, such as that of FIG. 4. In example (a) of FIG. 12C, an enhanced display panel includes an output surface, 1241, a display array 1261 and an illumination array 1271. The illumination array 1271 is an array of illumination units, such as the OLEDs in the layers 1-M of display/illumination layer 60C of FIG. 11C. The output surface 1241 may be similar to output surface 1004 of FIGS. 12A and 12B and acts to provide physical protection to the more sensitive display 1261 and illumination 1271 arrays. Beneath the output surface 1241, the display array 1261 may also be OLEDs like those of layers 1-M of display/illumination layer 60C of FIG. 11C except the output of the display layer 1261 is configured to output, under control of a controller (not shown), image light. In the configuration of example (a), the display array 1261 may be disposed beneath the illumination array 1271. The display array 1261 has the same resolution as the illumination layer 1271.

Another enhanced display panel configuration is illustrated in example (b) of FIG. 12C, the output surface 1242 is disposed above a display array 1262, which is disposed above the illumination array 1272. In contrast to the display 1261 and illumination 1271 arrays of example (a), the display array 1262 has a higher resolution than the illumination unit 1264 disposed underneath.

Examples (a) and (b) show only a single display array and a single illumination array. The OLED stack examples, such as those of FIGS. 11A-11E, illustrate multiple layers of OLEDS. Similarly, the display and illumination arrays may also be arranged in multiple layers as examples (c) and (d) of FIG. 12C illustrate. In example (c) of FIG. 12C, an output surface 1243 is the outermost layer with illumination layers 1253 and 1263 disposed beneath the output surface 1243. Disposed beneath the illumination layers 1253 and 1263 is display layer 1273. Other arrangements are also contemplated in which the display layer is disposed between illumination layers as shown in example (d) of FIG. 12C. In example (d), an output surface 1244 is the outermost layer followed by illumination layer 1254, higher resolution display layer 1264, and another illumination array 1274. Of course, more or less illumination layers may be incorporated in the examples (a) to (d).

It is also envisioned that multiple display arrays, such as 1273 or 1264 that are switchable between an image display state and a transparent state, may be incorporated in an enhanced display panel. The multiple display arrays may be each configured to present a predetermined image when switched to the image display state. Such an enhanced display panel is then controllable to present a first predetermined image, such as a first virtual luminaire image, via a first of the multiple display arrays, or present a second predetermined image, such as a second virtual luminaire image. Of course, other predetermined images may be used.

Although not shown, a non-transparent substrate or additional non-transparent light sources, such as 1110 or 1003 of FIGS. 12A and 12B, respectively, may be positioned as a last layer underneath, or in back of, the respective display and illumination arrays regardless of the order. By positioning light sources in the rear of the transparent OLED display device, the brightness and color rendering capability are enhanced. The lighting brightness and color rendering capability is determined by the lighting source positioned in the rear of the transparent OLED display device. For example, an RGB inorganic LED array may be positioned behind the transparent OLED display to enhance color rendering. The transparent OLED lighting enhancement units may provide beam shaping/beam steering functionality with inorganic light sources underneath. For example, the output format of optical beam can be electrically controlled by the beam steering/shaping OLED units as described above with reference to FIG. 11E.

OLEDs provide display and illumination versatility for an enhanced display device usable in a lighting device system such as that described in FIGS. 4 and 5A. In addition to the above enhancements, other improvements such as replacing the original organic emissive layer with a new emissive layer having higher efficiency, replacing the original organic transport layer with a new transport layer having a better carrier conductivity. In addition, another example of improving brightness to supplement the white sub-pixels. In addition to the commonly used red (R) sub-pixels, green (G) sub-pixels and blue (B) sub-pixels, white (W) sub-pixels may be added around the RGB sub-pixels to enhance the brightness. In yet another enhancement, instead of the original narrow band color filter which provides saturated color, wider band color filters may be used that provide wider spectrum thereby offering greater color rendering capability.

Although vertical configurations of OLED displays have been described with respect to the illustrated examples, it is also envisioned that a horizontal configuration may be implemented. In the horizontal OLED configuration, both a display and an illumination unit may be presented on the same surface with some spatial separation.

Another technology that is suitable as an enhanced display in the lighting device systems of FIGS. 4 and 5A, is a plasma display. As background, a conventional plasma display panel (PDP) is a matrix-like array of fluorescent tubes, and each pixel can be turned on and off. The fundamental unit of PDP is a plasma cell with dimensions on the order of 1 mm. A plasma cell is usually filled with xenon and neon gas mixture at higher than atmospheric pressure. The inner wall of a plasma cell is coated with red, green, or blue phosphor to provide three primary colors for display. The phosphor is sensitive to vacuum ultraviolet (UV), which is light of a wavelength between 100 and 200 nanometers, created from a plasma discharge. Typically, plasma is ignited and sustained by three electrodes, i.e. two coplanar electrodes are above the plasma cell and one data electrode is underneath. This operating configuration is named alternating-current coplanar (ACC) and is the mainstream of conventional commercial plasma TV. However, conventional PDPs, like conventional LCD displays, have very low efficacy even as a display device. The low efficacy is due to at least two reasons: 1) energy loss in the UV generation and 2) energy loss in the phosphor conversion of the generated UV light into visible light. The light energy lost from the conversion of the UV light to visible light is particularly difficult to overcome as approximately 85% of the input energy is wasted during the conversion. It is estimated that the effects of the different instances of energy loss results in at best a 2.25% overall efficiency for the PDP.

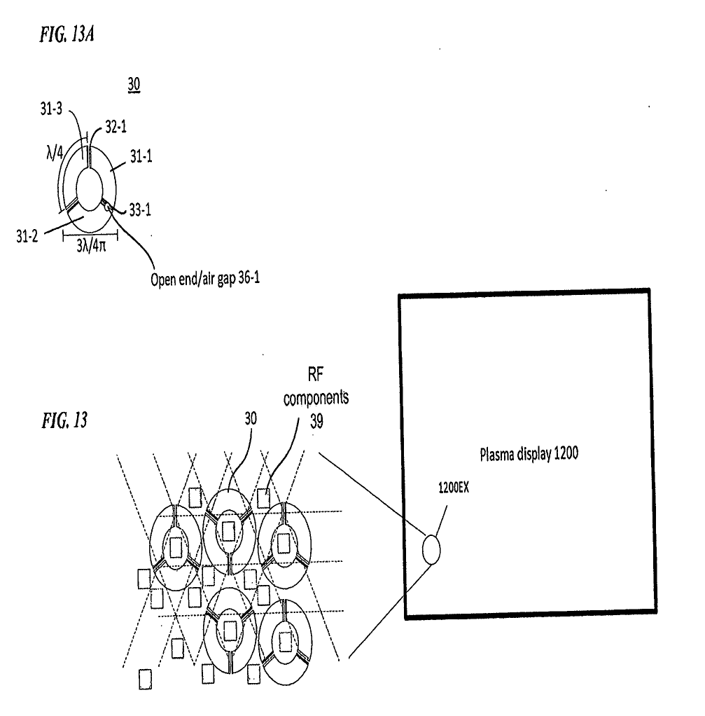

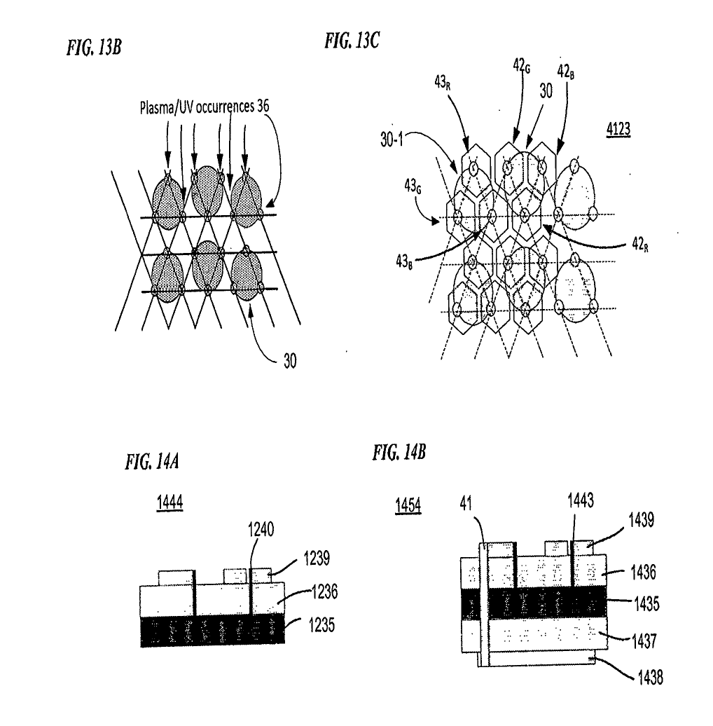

The discussion of FIGS. 13-15 relates to an addressable microplasma array that utilizes radio-frequency (RF) microstrip technology to produce visible light via plasma discharge for display and/or lighting applications. FIG. 13 is a high-level example of a portion 1200EX of a microplasma array of 3-cut resonators in a plasma display 1200 for providing a software configurable lighting apparatus, such as that of FIG. 4. The plasma display 1200 is a large addressable microplasma array. As shown in the magnified view, the portion of the addressable microplasma array 1200EX includes a number of individual RF resonator assemblies 30 with corresponding RF components 39.

An example of resonator assembly 30 is illustrated in FIG. 13A, and may be used to provide a plasma display device suitable for use in an example of a software configurable lighting apparatus, such as that of FIG. 4. The resonator assembly 30 may be either a line resonator or a split ring resonator. For ease of discussion and illustration, a 3-cut split ring resonator assembly 30 will be described, but a line resonator is similarly constructed and will operate and function in a similar manner. The resonator assembly 30 has a diameter of 3λ/4π, where λ, is the wavelength of the RF frequency being used. For example, the resonator assembly 30 may represent a pixel having a size of approximately 5 mm and generates plasma in response to an input frequency of approximately 15 GHz. The resonator assembly 30 is formed from three individual resonators 31-1, 31-2 and 31-3. The three individual-resonators 31-1, 31-2 and 31-3 that form resonator assembly 30 may be either a quarter-wavelength (and its integer multiples) resonator or a half-wavelength (and its integer multiples) resonator. For ease of explanation only the component parts of one of the three individual resonators of the resonator assembly 30 will be described. The individual resonator 31-1 is an example of a quarter-wave length resonator with one ground end 33-1 and one open end 36-1 between an adjacent resonator (e.g. 31-2 or 31-3). Alternatively, if individual resonator 31-1 were a half-wavelength (and its integer multiples) resonator it would have two open ends (not shown).

In operation of the individual resonator 31-1, at least one standing RF wave is formed at the open end 36, at which constructive interference occurs such that an electric field and the voltage at the open end 36 is maximized to the point sufficient to generate plasma. As a result of the existing oscillating electric field sufficient to generate plasma in the open end 36 between the open end 36 and the ground end 33, UV light is produced for conversion to output visible light. The open end 36 is a sealed cell (i.e., a glass air-tight cell) filled with a gas or gas mixture.

The generation of plasma in the portion of addressable microplasma array 1200EX of the display 1200 is illustrated in more detail in FIG. 13B. FIG. 13B is a plan view diagramming the location of the occurrence of microplasma generated in an array of resonators like that illustrated in the example of FIG. 13A. The occurrences plasma/UV light generated according to the described examples are shown occurring around perimeter of the resonators 30. The generated plasma produces UV light, which is converted using phosphors. An advantage of the described addressable microplasma array 1200EX is the increased phosphor conversion efficiency. In particular, unlike convention dielectric barrier discharge methods, RF microstrip discharge is not limited by separated electrodes to create a strong and fast oscillating electric field. The flexibility of the RF range enables the creation of microplasma for different gas mixtures at different gas pressures. For example, atmospheric helium, argon, or even air (i.e., 78% nitrogen+20% oxygen) have been demonstrated as capable of generating UV or near UV light whose wavelength is around 350 to 400 nm. UV light in this range results in a smaller Stokes shift and thus higher phosphor conversion efficiency. In other words, an advantage of the presently described resonators 30 in the addressable microplasma array 1200EX is that the output light efficacy of the plasma display 1200 is estimated as being at least 10 times greater than that of conventional plasma displays.

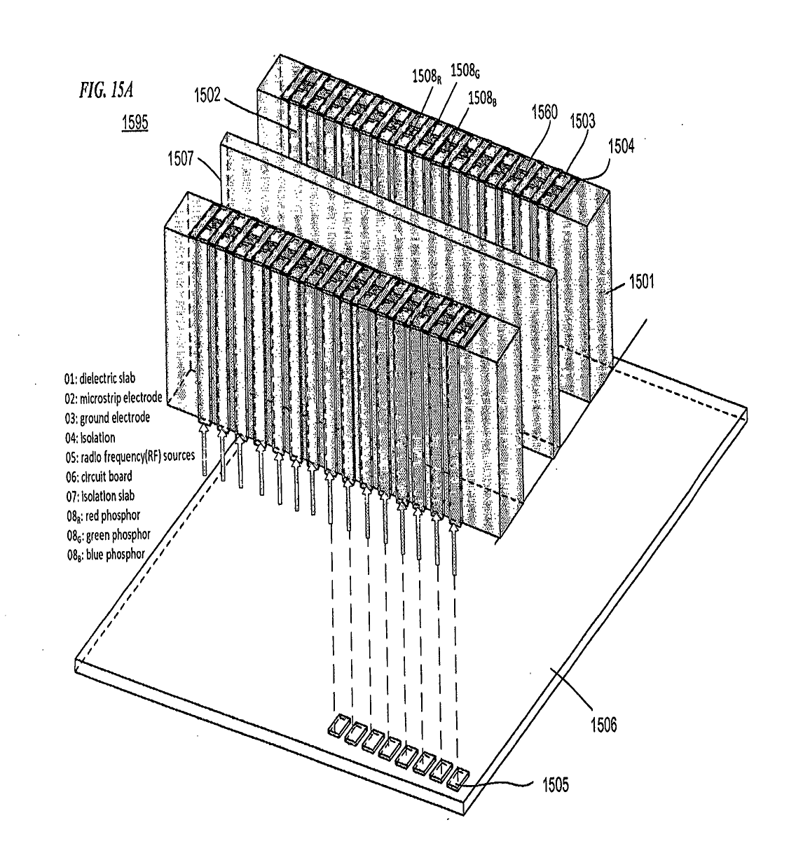

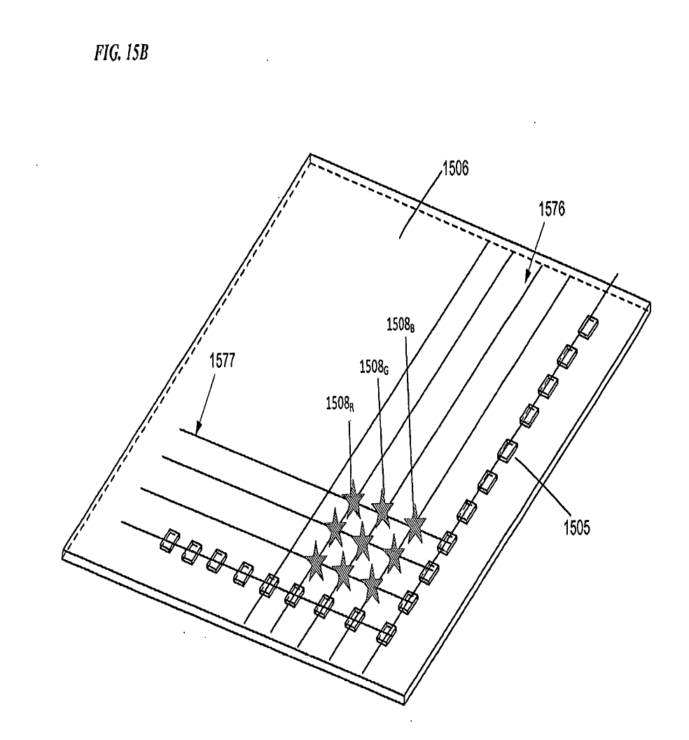

In order to provide color, color filters may configured to overlay the respective portions of a microplasma array 1200EX of the plasma display 1200. FIG. 13C illustrates an example of a portion of color filter implementation suitable for use with the 3-cut resonator example of FIG. 13. In the example of FIG. 13C, a color filtered microplasma array 4123 is shown with the color filters overlaying the microplasma array to provide a color-filtered microplasma array 4123. Individual color filters for each of the respective RGB colors are illustrated. For example, red (R), green (G) and blue (B) color filters 42R, 42G and 42B are shown disposed over each resonator 30 air gap in which plasma occurs. Similarly, color filters, such as color filters 43R, 43G and 43B may be positioned over an adjacent resonator, such as 30-1. Of course, other color configurations may be provided. For example, a single color filter, such red may be applied over each respective resonator, such as 30-1, such a configuration is illustrated in FIGS. 15A and 15B.

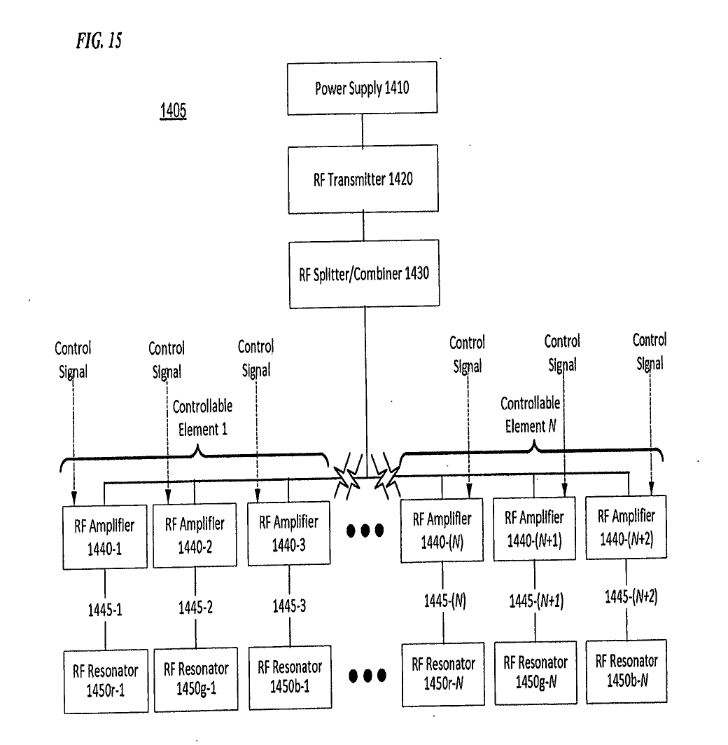

The described resonators, such as 30, may be fabricated as semiconductors as illustrated in FIGS. 14A and 14B. FIGS. 14A and 14B illustrate examples of semiconductor layer arrangements for providing the 3-cut resonator in a cell of a microplasma display as illustrated in the example of FIG. 13. In the example of FIG. 14A, the RF microstrip circuit board 1444 contains conducting microstrip channels and RF resonator 1239, dielectric substrate with circuitry 1236 and ground plate 1235 underneath the dielectric substrate 1236. A ground via 1240 is used to connect to the dielectric substrate 1236 or ground board 1235 to electric ground.

The RF microstrip circuit board 1444 may be one of many in the resonator array 1200EX that form the plasma display 1200. For example, each resonator 30 of FIG. 13 may have RF microstrip and resonator circuitry 30 as shown in FIG. 14A as well as the additional RF components 39 as shown in FIG. 13, such as the RF transmitter, the RF splitter/combiner and the RF amplifier, disposed on the same plane. However, in another example, the RF components 39 are may be disposed beneath the other RF microstrip and resonator circuitry 30. For example, as shown in FIG. 14B, the resonator array 1200EX may be mounted on one surface, and the RF components 39 may be disposed on the opposite side of the surface. In particular, the RF microstrip circuit board 1454 is formed with a ground plate 1435 on top of which is built the resonator 30 circuitry. A dielectric plate and circuit board 1436 is built on top of the ground plate 1435 and facilitates connectivity to the resonator 1439. A ground via 1443 enables the resonator 1439 to connect to the ground plane 1435, and similarly, an RF via 41 enables RF signals to be delivered to the resonator 1439. Beneath the ground plate 1435 are mounted another dielectric plate and circuit board 1437. Beneath the dielectric plate and circuit board 1437 is built the RF components 1438 (e.g., the RF transmitter, the RF splitter/combiner and/or the RF amplifier) that supply RF signals to the resonator 1439 through the RF via 41. In the example of FIG. 14B, the resonator 1439 array is built on one surface, and the RF power is delivered from the opposite surface where RF components 1438 are primarily located.

Either of the circuit configurations 1444 and 1454 may be incorporated in the plasma display 1200 to provide a display that provides both an image display and light suitable for general illumination (as discussed above).

Both of the circuit board examples of FIGS. 14A and 14B may also include transparent glass with a red, green, or blue phosphor pixel-related coating to seal the air or rare gas in a cell for plasma ignition. The brightness of the generated UV light (indicating the strength of the plasma reaction) is controlled by controlling the delivery of RF power to the respective individual air gaps in the resonator, such each of the three-cuts in the resonators 1239 or 1439. The generated UV light excites the phosphor pixel-related coating, in which case red, green, and blue light in one pixel is independently controlled. The described RF microstrip device may be used as a high efficient display and/or general illumination lighting device or apparatus.

A high-level overview of the operation of the plasma display 1200 is provided with reference to FIG. 15. FIG. 15 illustrates an example of a high-level control system configuration for controlling an array of 3-cut resonators, as in the portion of an array as in FIG. 13A to provide a software configurable lighting apparatus, such as that of FIG. 4. For each point in a resonator array, such as 1239 or 1439, microplasma is formed by the RF power via the RF components 1438 sent to the microstrip resonator 1439. Microstrip resonator 1439 helps delivering the maximum electric field into the microplasma by constructive interference. With proper gas mixture in proper pressure, e.g. atmospheric helium gas, microplasma is generated, by manipulated RF power, is each point in the array. Ultraviolet light is created by microplasma discharge and is converted to visible light by phosphor. By controlling RF power at each point in the array 1200EX, RF microstrip plasma display and RF microstrip plasma lighting may be achieved.

The plasma display/lighting system 1405 includes a power supply 1410, a radio frequency (RF) transmitter 1420, an RF splitter/combiner 1430, a number of RF amplifiers 1440-1 to 1440(N+2) and RF resonators 1450r-1 to 1450r-N, 1450g-1 to 1450g-N, and 1450b-1 to 1450b-N. In general, RF power generated by a solid-state RF transmitter 1420 is distributed by the RF splitter/combiner 1430 and the RF amplifiers 1440-1 to 1440-(N+2) using printed microstrip RF routing circuit 1445-1 to 1445-(N+2) to each RF resonator 1450r-1 to 1450r-N, 1450g-1 to 1450g-N, and 1450b-1 to 1450b-N in the plasma display 1200. The RF microstrip resonator 1439 may be impedance-matched with at least one standing wave existing to maximize the electric field at each resonator 1439 in the plasma display 1200.

In more detail, the RF splitters/combiners. 1430 distribute/superpose the RF power to/in different grid locations of an array within the plasma display 1200. Each of the RF amplifiers 1440-1 to 1440-(N+2) to amplify and modify RF power in each spatial location of the plasma display 1200.

The power supply 1410 provides input power to the control system, and may be provided via the AC mains to which a lighting device may be connected. The RF transmitter 1420 is configured to convert electrical power received via a connection the power supply 1410 to RF signal, and output the RF signal having a predetermined RF power. The RF splitter/combiner 1430 splits or divides the RF signal and distributes the RF power of the signal to each of the respective power amplifiers 1440-1 to 1440(N+2). The power amplifiers 1440-1 to 1440(N+2) are subdivided into a groups representing controllable elements. In the example of FIG. 14, the number of power amplifiers in a group is three (3); however, groups may have more or less power amplifiers. The power amplifiers are grouped into a group of three in the present example because the RF resonators are representative of specific colors, in this case, red (R), green (G) and blue (B). For example, controllable element 1 includes RF amplifiers 1440-1 to 1440-3, which are coupled to RF resonators 1450r-1, 1450g-1 and 1450b-1, respectively. Each of the RF amplifiers 1440-1 to 1440(N+2) receives RF power from the RF splitter/combiner 1430, and amplifies the RF power based on, or in response to, a control signal, which is based on the need of the respective RF resonator to which the RF amplifier is connected. In response to the amplified RF signal, the RF resonator maximizes the RF power at the open end and outputs of the resonator to generate microplasma. The generated microplasma is converted to visible light of a respective color via a color filter and output for use in providing either an image display or general illumination.

The individual semiconductor circuits of FIG. 14A or FIG. 14 may be fabricated on a semiconductor chip in an array to provide a display panel. FIG. 15A is a partial isometric view of an example of an RF microstrip resonator array in a plasma display as shown in the FIG. 13. FIG. 15B is a partial isometric view of an addressable array of RF microstrip resonators as shown in FIG. 15B.

The array of RF microstrips of 1505 is built upon a circuit board 1506. Each of the respective RF microstrips may be built upon a dielectric slab 1501 that includes an isolation slab 1507. Each of the RF microstrips that is built upon the dielectric slab 1501 may include a microstrip electrode 1502, a ground electrode 1503 as well as red phosphor 1508R, green phosphor 1508G, or blue phosphor 1508B, for the respective resonators. As shown, the respective red 1508R, green 1508G, or blue 1508B phosphors are shown as being applied over the entire 3 cuts of the resonators 1560; however, the respective phosphors may, as shown in FIG. 13B, be grouped over a resonator, such as 1560. Each of resonator 1560 may be isolated from other resonators via isolation 1504. In addition, the resonators 1560 are coupled to radio frequency (RF) sources 1505 to receive individual RF power.

FIG. 15B illustrates a high-level isometric view of circuit board 1506 illustrating the array arrangement of the RF microstrip resonators 1560 (of FIG. 15A) that enables individual addressability. In the example, each resonator (shown beneath respective phosphors 1508R, 1508G and 1508B) is individually addressable via RF signal lines 1576 and 1577. Control of the respective RF signals provided may be provided by a controller (not shown). The controller may provide control signals to the individual resonators to generate the appropriate color output to generate either white or red, green or blue lighting via phosphors 1508R, 1508G, and 1508B based on configuration data, or the like.

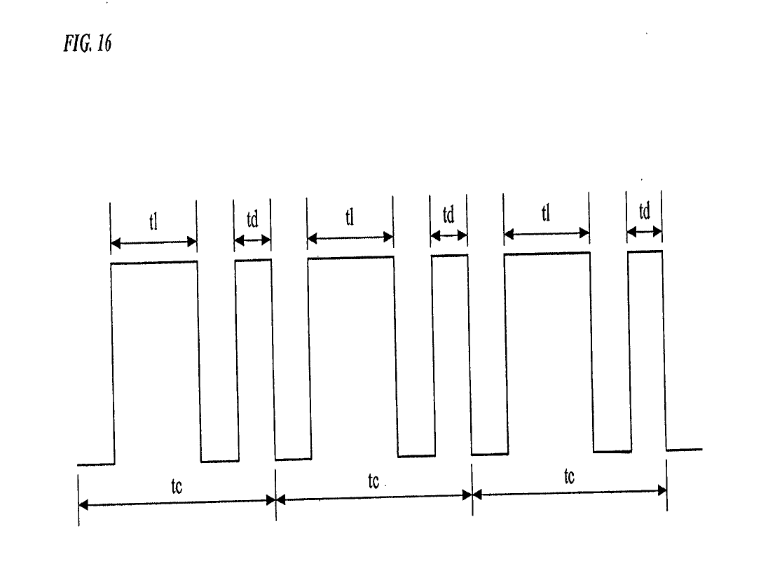

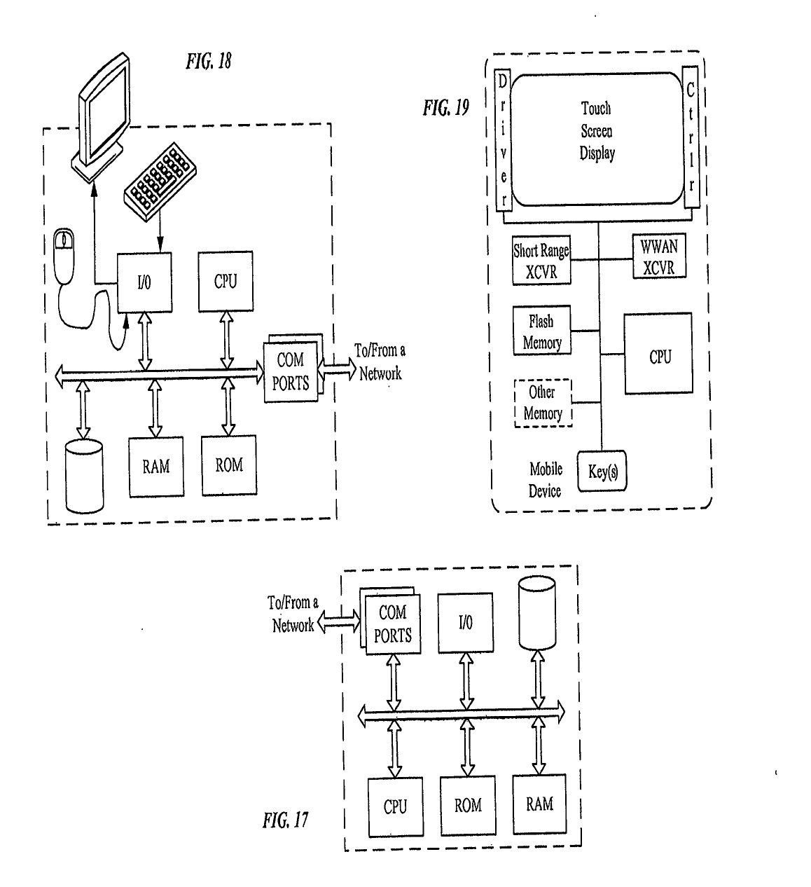

As shown by the above discussion, although many intelligent processing functions are implemented in lighting device, at least some functions may be implemented via communication with general purpose computers or other general purpose user terminal devices, although special purpose devices may be used. FIGS. 17-19 provide functional block diagram illustrations of exemplary general purpose hardware platforms.

FIG. 17 illustrates a network or host computer platform, as may typically be used to generate and/or receive lighting device 11/11A control commands and access networks and devices external to the lighting device 11/11A, such as host processor system 115 of FIG. 1 or 4 or implement light generation and control functionality of driver system 113/113A. FIG. 18 depicts a computer with user interface communication elements, such as 117/117A as shown in FIGS. 1 and 4, although the computer of FIG. 18 may also act as a server if appropriately programmed. The block diagram of a hardware platform of FIG. 19 represents an example of a mobile device, such as a tablet computer, smartphone or the like with a network interface to a wireless link, which may alternatively serve as a user terminal device for providing a user communication with a lighting device, such as 11/11A. It is believed that those skilled in the art are familiar with the structure, programming and general operation of such computer equipment and as a result the drawings should be self-explanatory.

A server (see e.g. FIG. 17), for example, includes a data communication interface for packet data communication via the particular type of available network. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load. A server, such as that shown in FIG. 17, may be accessible or have access to a lighting device 11/11A via the communication interfaces 117/117A of the lighting device 11/11A. For example, the server may deliver in response to a user request a configuration information file. The information of a configuration information file may be used to configure a software configurable lighting device, such as lighting device 11/11A, to set light output parameters comprising: (1) light intensity, (2) light color characteristic and (3) spatial modulation, in accordance with the lighting device configuration information. In some examples, the lighting device configuration information include an image for display by the lighting device and at least one level setting for at least one of beam steering or beam shaping by the lighting device. The configuration information file may also include information regarding the performance of the software configurable lighting device, such as dimming performance, color temperature performance and the like. The configuration information file may also include temporal information such as when to switch from one beam shape or displayed image to another and how long the transition from one state to another should take. Configuration data may also be provided for other states, e.g., for when the virtual luminaire is to appear OFF, in the same or a separate stored data file.

A computer type user terminal device, such as a desktop or laptop type personal computer (PC), similarly includes a data communication interface CPU, main memory (such as a random access memory (RAM)) and one or more disc drives or other mass storage devices for storing user data and the various executable programs (see FIG. 18). A mobile device (see FIG. 19) type user terminal may include similar elements, but will typically use smaller components that also require less power, to facilitate implementation in a portable form factor. The example of FIG. 19 includes a wireless wide area network (WWAN) transceiver (XCVR) such as a 3G or 4G cellular network transceiver as well as a short range wireless transceiver such as a Bluetooth and/or WiFi transceiver for wireless local area network (WLAN) communication. The computer hardware platform of FIG. 17 and the terminal computer platform of FIG. 18 are shown by way of example as using a RAM type main memory and a hard disk drive for mass storage of data and programming, whereas the mobile device of FIG. 19 includes a flash memory and may include other miniature memory devices. It may be noted, however, that more modern computer architectures, particularly for portable usage, are equipped with semiconductor memory only.

The various types of user terminal devices will also include various user input and output elements. A computer, for example, may include a keyboard and a cursor control/selection device such as a mouse, trackball, joystick or touchpad; and a display for visual outputs (see FIG. 18). The mobile device example in FIG. 19 uses a touchscreen type display, where the display is controlled by a display driver, and user touching of the screen is detected by a touch sense controller (Ctrlr). The hardware elements, operating systems and programming languages of such computer and/or mobile user terminal devices also are conventional in nature, and it is presumed that those skilled in the art are adequately familiar therewith.

The user device of FIG. 18 and the mobile device of FIG. 19 may also interact with the lighting device 11/11A in order to enhance the user experience. For example, third party applications stored as programs 127/127A may correspond to control parameters of a software configurable lighting device, such as image display and general illumination lighting distribution. In addition in response to the user controlled input devices, such as I/O of FIG. 18 and touchscreen display of FIG. 19, the lighting device, in some examples, is configured to accept input from a host of sensors, such as sensors 121/121A. These sensors may be directly tied to the hardware of the device or be connected to the platform via a wired or wireless network. For example, a daylight sensor may be able to affect the light output from the illumination piece of the platform and at the same time change the scene of display as governed by the algorithms associated with the daylight sensor and the lighting platform. Other examples of such sensors can be more advanced in their functionality such as cameras for occupancy mapping and situational mapping.

The lighting device 11/11A in other examples is configured to perform visual light communication. Because of the beam steering (or steering) capability, the data speed and bandwidth can have an increased range. For example, beam steering and shaping provides the capability to increase the signal-to-noise ratio (SNR), which improves the visual light communication (VLC). Since the visible light is the carrier of the information, the amount of data and the distance the information may be sent may be increased by focusing the light. Beam steering allows directional control of light and that allows for concentrated power, which can be a requirement for providing highly concentrated light to a sensor. In other examples, the lighting device 11/11A is configured with programming that enables the lighting device 11/11A to “learn” behavior. For example, based on prior interactions with the platform, the lighting device 11/11A will be able to use artificial intelligence algorithms stored in memory 125/125A to predict future user behavior with respect to a space.

As also outlined above, aspects of the techniques form operation of a software configurable lighting device and any system interaction therewith, may involve some programming, e.g. programming of the lighting device or any server or terminal device in communication with the lighting device. For example, the mobile device of FIG. 19 and the user device of FIG. 18 may interact with a server, such as the server of FIG. 17, to obtain a configuration information file that may be delivered to a software configurable lighting device 11/11A. Subsequently, the mobile device of FIG. 19 and/or the user device of FIG. 18 may execute programming that permits the respective devices to interact with the software configurable lighting device 11/11A to provide control commands such as the ON/OFF command or a performance command, such as dim or change beam steering angle or beam shape focus. Program aspects of the technology discussed above therefore may be thought of as “products” or “articles of manufacture” typically in the form of executable code and/or associated data (software or firmware) that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software or firmware programming. All or portions of the programming may at times be communicated through the Internet or various other telecommunication networks. Such communications, for example, may enable loading of the software from one computer or processor into another, for example, from a management server or host computer of the lighting system service provider into any of the lighting devices, sensors, user interface devices, other non-lighting-system devices, etc. of or coupled to the system 11/11A via communication interfaces 117/117A, including both programming for individual element functions and programming for distributed processing functions. Thus, another type of media that may bear the software/firmware program elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible or “storage” media, terms such as computer or machine “readable medium” refer to any medium that participates in providing instructions to a processor for execution.

The term “coupled” as used herein refers to any logical, physical or electrical connection, link or the like by which signals produced by one system element are imparted to another “coupled” element. Unless described otherwise, coupled elements or devices are not necessarily directly connected to one another and may be separated by intermediate components, elements or communication media that may modify, manipulate or carry the signals.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A lighting device, comprising:
a light source configured to generate light suitable for delivering general illumination of a space;
a switchable diffuser coupled to receive light output from the light source, the switchable diffuser structured to be switchable between a display mode and an illumination mode;
one or more switchable polarizers, wherein each of the one or more switchable polarizers is structured to be switchable between a display mode and an illumination mode;
a liquid crystal filter that is electrically controllable and passes light generated by the light source; and
a controller, coupled to the light source, the switchable diffuser, the one or more switchable polarizers and the liquid crystal filter, to control operation of the light source, the switchable diffuser, the one or more switchable polarizers and the liquid crystal filter.

2. The lighting device of claim 1, further comprising:
one or more quarter-wave plates configured to pass light having a predetermined polarization.

3. The lighting device of claim 1, wherein the liquid crystal filter is controllable to emit light of different colors based on control signals received from the controller.

4. The lighting device of claim 1, wherein the light source is a light source selected from the group consisting of a compact fluorescent light, a fluorescent light, one or more light emitting diodes and a halogen lamp.

5. The lighting device of claim 1, wherein the controller is further configured to, according to a time division multiplexing scheme:
generate control signals presenting for switching the switchable diffuser, both of the one or more polarizers and the liquid crystal filter to a display mode in which the lighting device presents an image based on the received image data during a first periodic interval of the time division multiplexing scheme; and
generate control signals for switching the switchable diffuser, both of the one or more polarizers and the liquid crystal filter to an illumination mode in which for the lighting device generates illumination lighting to compliment the light output from the general illumination device during a second periodic interval of the time division multiplexing scheme different from the first periodic interval.

6. A device, comprising:
a light source;
a display; and
a controller, coupled to the light source and the display, the controller configured to:
in an illumination mode, operate the device to output light from the light source to provide general illumination to a premises; and
in a display mode, operate the device to output an image via the display.

7. The device of claim 6, wherein the general illumination satisfies a governmental or an industry standard for a general lighting application.

8. The device of claim 6, wherein the light source has a light output value that is greater in the illumination mode than in the display mode.

9. A display device, comprising:
a light source configured to generate light for output from the display device; and
one or more controllable light processing components coupled to the light source for processing the output light according to a display device mode, the light source and the one or more controllable light processing components configured to:
in a first mode, output general illumination lighting over the entire output surface of the display device; and
in a second mode, generate a display of an image over an entire output surface of the display device.

10. The display device of claim 9, further comprising:
a control means coupled to the light source and the one or more controllable light processing components, the control means configured to:
control the one or more controllable light processing components to provide a transparent state during the first mode; and
control the one or more controllable light processing components to provide a diffuse state during the second mode.

11. The display device of claim 9, further comprising:
a control means configured to control the light source to generate light suitable to produce the image, wherein an intensity of the generated light is reduced in the second mode as compared to the intensity of the generated light when in the first mode.

12. The display device of claim 9, wherein the one or more controllable light processing components are further configured to:
in a third mode, output an image in a portion of the output surface of the display device while one or more other portions of the output surface of the display device are controlled to output light for the general illumination.

13. The display device of claim 9, wherein the light source has a light output value that is greater in the first mode than in the second mode.

14. An apparatus, comprising:
a controllable source of light;
a controllable display device; and
means for selectively operating the apparatus at different times in different first and second modes, the first mode including outputting light from the light source to provide general illumination to a premises, and the second mode including operating the display device to output an image.

15. The apparatus of claim 14, wherein the means are configured to time division multiplex the operations of the apparatus in the different first and second modes.

16. The apparatus of claim 14, wherein operation in the first mode provides the output of light for the general illumination over an entire output surface of the controllable display device, and operation in the second mode provides the image display output over the entire output surface of the controllable display device.

17. The apparatus of claim 14, wherein the means are further configured for selectively operating the apparatus at a further different time in a third mode, the third mode including outputting light from the light source to provide general illumination to a premises and operating the display device to output an image.
